(19) United States
(12) Patent Application Publication
(10) Pub. No.: US 2015/0278779 A1
(43) Pub. Date: Oct. 1, 2015

(54) METHODS AND SYSTEMS FOR COMMERCE ON SOCIAL MEDIA PLATFORMS

(71) Applicant: GoodWorld, Inc., Washington, DC (US)

(72) Inventor: Dale Marie PFEIFER, Washington, DC (US)

(21) Appl. No.: 14/668,623

(22) Filed: Mar. 25, 2015

Related U.S. Application Data
(60) Provisional application No. 61/970,123, filed on Mar. 25, 2014.

(51) Int. Cl. G06Q 20/10; G06Q 30/02; G06Q 50/00

(52) U.S. Cl. CPC G06Q 20/102; G06Q 50/01; G06Q 30/0279

(57) ABSTRACT

Aspects described herein relate to facilitating financial transactions to a payee account based on social media content. Content is received from the social media platform relating to the payee account, and a sequence of characters in the content can be detected, which indicate initiation of a financial transaction. An initiator account on the social media platform that is associated with the sequence of characters is determined, and the financial transaction can be initiated based at least in part on the initiator account, detecting the sequence of characters, and the payee account.

### CLAIM OF PRIORITY UNDER 35 U.S.C. §119

The present application for patent claims priority to Provisional Application No. 61/970,123 entitled “ZERO-CLICK IN-STREAM COMMERCE ON MAJOR SOCIAL MEDIA PLATFORMS” filed Mar. 25, 2014, which is hereby expressly incorporated by reference herein for all purposes.

### BACKGROUND

Traditionally, charitable organizations have utilized a variety of forms of media, including the Internet, to provide individuals with information. Information is often provided to individuals by charitable organizations in hopes of gaining support for the organization, and, at least in part, such support generally takes the form of monetary donations made to the charitable organization by individual donors.

Recently, with the rising popularity of social networking sites, charitable organizations have begun to provide users of social networking sites with information regarding the charitable organization by establishing an online presence within the social networking environment. The online presence of a charitable organization in a social networking environment may be established in a variety of manners including through a social network system user, non-person entity, content item, group, or social network system page. For example, charitable organizations can set up accounts that can post social networking messages and/or provide users of the social network with information about the charitable organization and can link users of the social network to other information about the charitable organization that is located outside of the social networking environment. Similarly, charitable organizations can set up social network system pages that allow users of the social networking site who visit the page to find out more information about the charitable organization, and these pages can link the user of the social networking site to outside information, such as the Internet website of the charitable organization. Charitable organizations have also solicited charitable donations from users of social networks, but users of social networking sites have generally been required to leave the social networking environment and go to the Internet website of the charitable organization before making a charitable donation. Moreover, charitable monetary donations are typically solicited from individual users of a social networking site to support the charitable organizations overall mission. For example, a charitable organization may post information in the social networking environment about the charitable organization that includes a link to the charitable organization's Internet website, and users of the social networking site could visit the Internet website of the charitable organization. However, only when the user of the social networking site leaves the social networking environment and visits the charitable organization's Internet website would the user of the social networking site then have the option of making a charitable monetary donation to the charitable organization. Thus, although the user of the social network may originally learn about the charitable organization through the social networking environment, the charitable donation that the user of the social network makes to the charitable organization can occur only when the user of the social network visits another site, such as the charitable organization's Internet website.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an example, a method for facilitating financial transactions to a payee account based on social media content is provided. The method includes receiving content from the social media platform relating to the payee account, detecting a sequence of characters in the content indicating initiation of a financial transaction, determining an initiator account on the social media platform that is associated with the sequence of characters, and initiating the financial transaction based at least in part on the initiator account, detecting the sequence of characters, and the payee account.

In another example, a system for facilitating financial transactions to a payee account based on social media content is provided. The system includes a platform integrating component configured to receive content from the social media platform relating to the payee account, a content-processing component configured to detect a sequence of characters in the content indicating initiation of a financial transaction, and to determine an initiator account on the social media platform that is associated with the sequence of characters, and a transaction-initiating component configured to initiate the financial transaction based at least in part on the initiator account, detecting the sequence of characters, and the payee account.

In another example, a non-transitory computer-readable medium for facilitating financial transactions to a payee account based on social media content is provided. The non-transitory computer-readable medium includes code for receiving content from the social media platform relating to the payee account, code for detecting a sequence of characters in the content indicating initiation of a financial transaction, code for determining an initiator account on the social media platform that is associated with the sequence of characters, and code for initiating the financial transaction based at least in part on the initiator account, detecting the sequence of characters, and the payee account.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 illustrates an example system for initiating financial transactions based on social media content.

FIG. 2 illustrates an example method for initiating financial transactions based on social media content.

FIG. 3 illustrates an example method for initiating payments for financial transactions based on social media content.

FIG. 4 illustrates an example system for communicating with a payment management platform and a social media platform.

FIG. 5 illustrates an example methodology for generating social media content to cause initiation of a financial transaction.

FIGS. 6-8 illustrate example flowcharts of data between a social media platform and payment management platform.

FIGS. 9 and 10 illustrate example interfaces of social media platform feeds.

FIG. 11 illustrates an example flowchart of data between a social media platform and payment management platform.

FIG. 12 illustrates an example interface of social media platform feeds.

FIGS. 13-22 illustrate example graphical user interface (GUI) screens in accordance with aspects described herein.

FIG. 23 is an example system diagram of various hardware components and other features, for use in accordance with aspects described herein.

FIG. 24 is a block diagram of various example system components, for use in accordance with aspects described herein.

### DETAILED DESCRIPTION

Aspects described herein generally relate to integrating a payment management platform with a social media platform, such as Facebook or Twitter, for example, to facilitate initiation of financial transactions by content of the social media platform. For example, the payment management platform may receive content from the social media platform, and may search the content to detect one or more sequence of characters indicative of a desire to initiate a financial transaction, and may accordingly initiate the financial transaction. In one example, the payment management platform may include a set of payor accounts that can each be associated with social media accounts on the social media platform. Accordingly, when the payment management platform encounters the detected sequence of characters, it can determine the social media account to which the sequence of characters relate (e.g., the social media account that authored the sequence of characters). The payment management platform may then process the financial transaction based at least in part on determining the payor account associated with the social media account. This social media account is also referred to herein as an initiator account. Thus, the initiator account may initiate a financial transaction via the social media platform without necessarily having to leave the social media platform to process payment. In addition, the initiator account may specify, via the social media platform, whether and/or how to publicize the donation (e.g., publicize to friends, friends' networks, everyone, etc.).

In addition, the payment management platform may determine a payee account associated with the sequence of characters, which may include a payee indicated as part of the sequence of characters. In another example, the payment management platform may include a set of payee accounts as well that can each be associated with social media accounts on the social media platform. Thus, for example, the payment management platform may determine the payee account to which the financial transaction relates based on additional parameters associated with the sequence of characters, such as another social media account specified within or around the sequence of characters (e.g., an account specified by the initiator account), a social media account that authored a social media page on which the sequence of characters are posted by the initiator account, etc. The payment management platform may then process the financial transaction based at least in part on determining the payee account associated with the social media account as well. This social media account is also referred to herein as a receiver account. In any case, processing the transaction may be based at least in part on payment information specified for the payor account, and may include communicating with a financial institution related to the payment information to process a payment from the payor account to the payee account.

In a specific example, charitable organizations can generate donation campaigns by using a social media account on a social media platform, such as on a page viewable by the public or at least by social media connections (e.g., “friends”) of the charitable organization. Charitable organizations, as referred to herein, can include 501(c)(3) organizations, but should be understood to include substantially any organization that can take donations or payments such as, but not limited to, a political campaign, a school, a church, a for-profit business (e.g., running a donation campaign for a related or unrelated party, a start-up business, etc.), individuals that create a donation campaign (e.g., for family member medical expenses, for artistic creations, for research, etc.), and/or substantially any party that can create a social media account and can receive money. A 501(c)(3) organization, as referred to herein, can include an organization that is exempt from paying taxes (e.g., under the United States Internal Revenue Code) by virtue of its status as an organization that is formed and operated exclusively for one or more of the following purposes: “Religious, Educational, Charitable, Scientific, Literary, Testing for Public Safety, to Foster National or International Amateur Sports Competition, or Prevention of Cruelty to Children or Animals.” The Internal Revenue Service (IRS) provides a publically available list of registered 501(c)(3) organizations, and such information may also be provided by individual states. The charitable monetary donation may include a contribution of cash, check, or other monetary gift (regardless of amount) that is made to a qualified organization, such as a charitable organization. The charitable organization may also register for a payee account at the payment management platform, which may be linked to the social media account of the charitable organization and/or for an individual seeking to promote the charitable organization and/or a related donation campaign. The payment management platform may monitor content on the donation campaign page (e.g., and/or other pages, walls, timelines, messages, etc. related to the social media account of the charitable organization, group related to or otherwise attended by the charitable organization) for sequences of characters that indicate a desire to donate to the charitable organization. In an example, the sequence of characters may include “#donate” which may or may not also include a dollar amount. Where the payment management platform detects the sequence of characters posted by a donor (initiator) account (e.g., as a comment, new post, etc.) to a page, wall, timeline, message, etc. of the charitable organization (receiver) account or related group, the payment management platform may accordingly process a donation to the charitable organization (payee) account associated with the corresponding social media account. If the payment management platform determines that the donor (initiator) account has a corresponding payor account, the donation can be processed based on payment information stored for the corresponding payor account. If no payor account is located, the payment management platform may allow the donor (initiator) account to register for a payor account and process the donation.

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used herein, the term “determining” or “evaluating” encompasses a wide variety of actions. For example, “determining” and “evaluating” may include calculating, computing, processing, deriving, investigating, looking up (e.g., looking up in a table, a database or other data repository, or another data structure), ascertaining, and/or the like. Also, “determining,” and “evaluating” may include receiving (e.g., receiving information), accessing (e.g., accessing data in a data repository), and/or the like. Also, “determining” may include resolving, selecting, choosing, establishing, and the like.

As used herein, the terms “element,” “module,” “component,” and “system” may refer to a computer-related entity, either hardware, a combination of hardware and software, software, or software in execution. For example, a module may be, but is not limited to being, a machine-executable process running on a processor, a processor, an object, a thread of execution, a machine-executable program, and/or a computer. By way of illustration, both a process running on a server and the server may be a module or a component. One or more modules or components may reside within a process and/or thread of execution. In some implementations, a module may be localized on one computer and/or distributed among two or more computers.

It will be appreciated that, in accordance with one or more aspects described herein, inferences may be made regarding determining protocols to provide to the application, analyzing data for performance of the protocols, and/or the like, as described. As used herein, the term to “infer” or “inference” refers generally to the process of reasoning about or inferring states of the system, environment, and/or user from a set of observations as captured via events and/or data. Inference may be employed to identify a specific context or action, or may generate a probability distribution over states, for example. The inference may be probabilistic—that is, the computation of a probability distribution over states of interest based on a consideration of data and events. Inference may also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Various aspects or features will be presented herein in terms of systems that may include a number of devices, components, modules, and the like. It is to be understood and appreciated that the various systems may include additional devices, components, modules, etc. and/or may not include all of the devices, components, modules, etc., discussed in connection with the figures. A combination of these approaches may also be used.

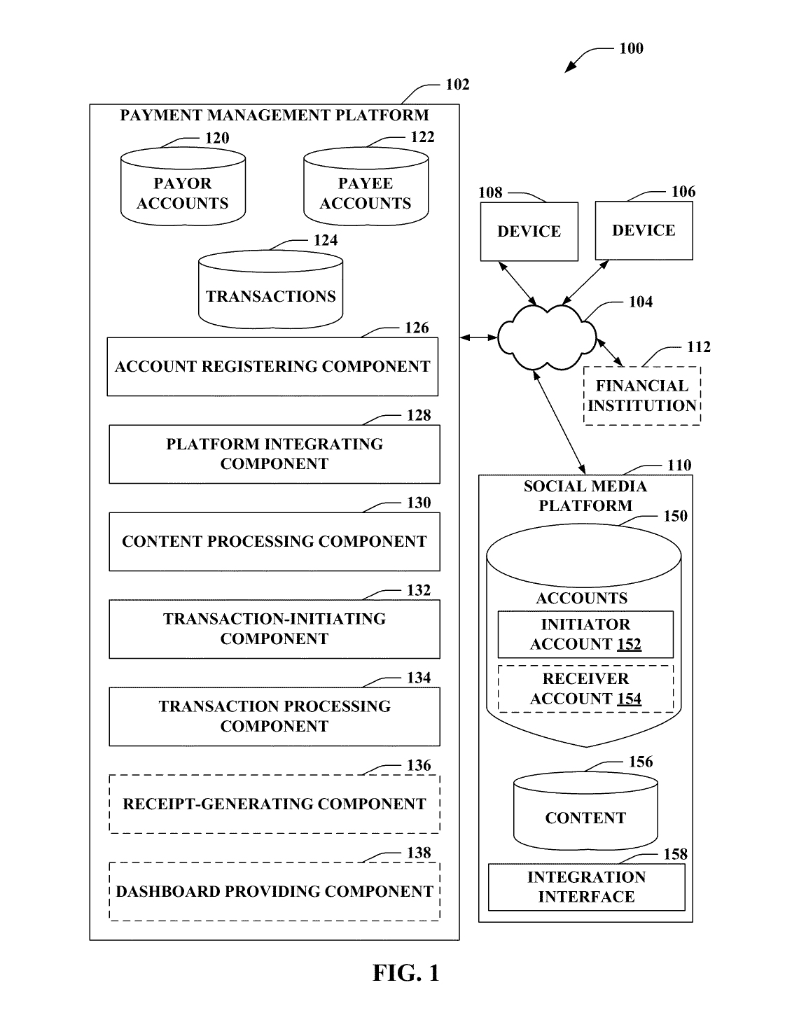

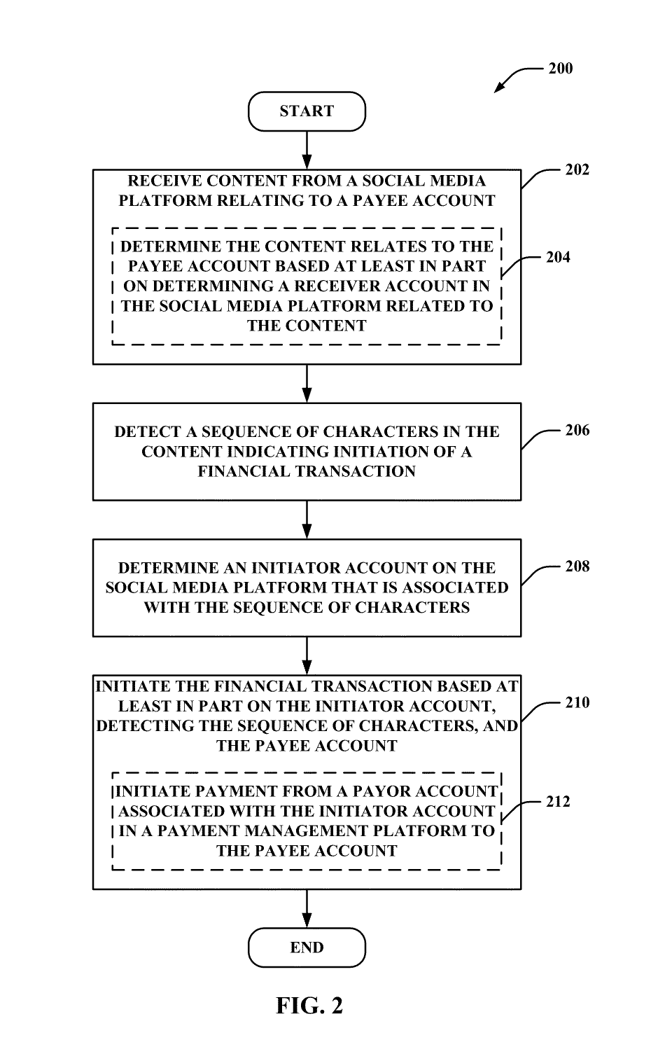

Referring to FIGS. 1-5, aspects are depicted with reference to one or more components and one or more methods that may perform the actions or functions described herein. Although the operations described below in FIGS. 2, 3, and 5 are presented in a particular order and/or as being performed by an example component, it should be understood that the ordering of the actions and the components performing the actions may be varied, depending on the implementation. Moreover, it should be understood that the following actions or functions may be performed by a specially-programmed processor, a processor executing specially-programmed software or computer-readable media, or by any other combination of a hardware component and/or a software component capable of performing the described actions or functions.

Referring to FIG. 1, an example system 100 is illustrated that facilitates processing financial transactions based on detected social media content. System 100 includes a payment management platform 102 for processing financial transactions between payor and payee accounts, and communicates over a network 104 (e.g., the Internet) with one or more other nodes. System 100 also includes devices 106 and 108 that can communicate over the network 104 with a social media platform 110 to communicate using social networking, the payment management platform 102 to register for payor or payee accounts, which may link to accounts on the social media platform 110 (and/or additional social media platforms), etc. System 100 can also optionally include one or more financial institutions 112 to which payment management platform 102 can communicate to process one or more financial transactions.

Payment management platform 102 includes a plurality of payor accounts 120 and a plurality of payee accounts 122, which can be added, modified, deleted, etc. in a repository at the payment management platform 102. Payment management platform 102 can also include a plurality of transactions 124 between one or more of the payor accounts 120 and the payee accounts 122, where the transactions 124 may be added, modified, deleted, etc. in a repository at the payment management platform 102. Payment management platform 102 also includes an account registering component 126 to facilitate registering payor accounts 120 and payee accounts 122, a platform integrating component 128 for communicating with and receiving content from another platform, a content processing component 130 for determining whether to initiate financial transactions based on the content, a transaction-initiating component 132 for initiating a transaction between a payor account and payee account based on the content, and/or a transaction processing component 134 for completing the transaction between the payor account and the payee account. Payment management platform 102 may optionally include a receipt-generating component 136 for creating a receipt for the financial transaction, and/or a dashboard providing component 138 for generating a dashboard interface that includes parameters of transactions related to a given payor or payee account.

Social media platform 110 can include a plurality of accounts 150, which can be added, modified, deleted, etc. in a repository at the social media platform 110, and can include initiator accounts 152 linked to payor accounts at the payment management platform 102 and/or receiver accounts 154 linked to payee accounts at the payment management platform 102. It is to be appreciated that a receiver account 154 may be owned by the same entity/individual as the payee account and/or may be for an individual that is receiving money on behalf of the payee account (e.g., an individual running a donation campaign for a donee related to the payee account). Moreover, social media platform 110 may include content 156, which is authored by one or more accounts 150 and can relate to one or more other accounts 150, and an integration interface 158 for communicating at least a portion of the content 156 to one or more other platforms.

According to an example, device 106 or 108 can communicate with payment management platform 102 to register for a payee account. In this regard, payment management platform 102 can provide an interface to the device 106 or 108 for registering, which may include a webpage on a website hosted by the payment management platform 102, a page in a device application provided by the payment management platform 102, etc. For example, account registering component 126 can provide the interface, and can accept data input by the device 106 or 108 on the interface, which may include a user name for the payee account, information for linking to the payee account to social media content (e.g., one or more social media accounts related to the payee on one or more social media platforms 110, a sequence of characters to identify the payee in the one or more social media platforms 110, etc.), information for receiving payment from payor accounts (e.g., an automatic clearing house (ACH) account number at a bank of the payee, account information for digital payment systems, digital wallet, PayPal, bitcoin, etc.), and/or the like. Account registering component 126 can store the information as one of payee accounts 122. In addition, payment management platform 102, in this regard, allows for a single point for signing up to receive financial transactions over one or more social media platforms 110.

Platform integrating component 128 can access integration interface 158 of the social media platform to receive at least a portion of content 156. For example, integration interface 158 may allow for specifying a portion of content 156 to receive, such as a portion related to one or more specific accounts (e.g., content posted to a page, wall, timeline, message, etc. of the one or more specific accounts), a portion that includes a specific sequence of characters (e.g., a hashtag phrase, or substantially any sequence of characters, etc.), and/or the like. Thus, platform integrating component 128 can specify the portion of content 156 to receive to integration interface 158 (or can receive all content), where the portion of content can relate to the information linking the payee account to the social media content, as specified during registration of the payee account. For example, the portion of content requested by the platform integrating component 128 can include content related to a social media account linked to the payee account, content related to a sequence of characters to identify the payee in the social media content, etc. Integration interface 158 can accordingly provide relevant content to the platform integrating component 128 (e.g., in a subscription-based communication, in a request/response manner, etc.). It is to be appreciated that platform integrating component 128 can receive content from integration interface 158 that relates to all payee accounts 122 in one feed and can accordingly determine when content 156 relates to a given payee account, or can receive a separate feed of content 156 for each of payee accounts 122, etc.

Content processing component 130 can process the portion of content 156 received from the integration interface 158 to determine if any of the portion of content 156 relates to initiating a financial transaction to a given payee. For example, content processing component 130 can search the portion of content 156 to detect a sequence of characters indicating a desire to initiate a financial transaction. Thus, for example, the sequence of characters may be detected in content authored by an initiator account 152 that specifies the information for linking to the payee account to social media content (e.g., a name of the payee registered in the payment management platform). In another example, the sequence of characters may be detected in content authored by an initiator account 152 on a receiver account 154 in the social media platform 110 relating to the payee account (e.g., content authored by the initiator account 152 on a page, wall, timeline, etc. of the receiver account 154, in a message to or that otherwise specifies the receiver account 154, etc.).

Where content processing component 130 detects the sequence of characters, transaction-initiating component 132 can initiate the financial transaction to the payee account. For example, content processing component 130 may determine the initiator account 152 in the social media platform 110 that authored the content, and transaction-initiating component 132 may determine whether the initiator account 152 has a corresponding payor account registered in payor accounts 120. If so, transaction-initiating component 132 can initiate a transaction from the payor account to the payee account based at least in part on payment information specified for the payor account, which may include storing the related information in transactions 124 as a pending transaction. If not, transaction-initiating component 132 can store the related information in transactions 124 as a pending transaction without an associated payor account, and, in one example, may cause prompting to the corresponding initiator account 152 to register with the payment management platform 102. In either case, transaction-initiating component 132 may provide an indication that the transaction is pending to social media platform (e.g., via integration interface 158) for integrating in content related to the initiator account 152 (e.g., on the page, wall, timeline, etc. where the initiator account 152 posted the content to initiate the financial transaction, as a pop-up or private message to the initiator account 152, etc.). Where no payor account is found, the indication to the initiator account 152 may include a link to register with the payment management platform 102, a link to provide additional information to process the financial transaction (e.g., payment information), etc., for example.

Whether performed before or after initiation of the financial transaction, device 106 or 108 can communicate with payment management platform 102 to register for a payor account. In this regard, payment management platform 102 can provide an interface to the device 106 or 108 for registering, which may include a webpage on a website hosted by the payment management platform 102, a page in a device application provided by the payment management platform 102, etc. For example, account registering component 126 can provide the interface, and can accept data input by the device 106 or 108 on the interface, which may include a user name for the payor account, one or more social media account on one or more social media platforms (e.g., initiator account 152) related to the payor, payment information for facilitating payments from payor accounts (e.g., a credit card number, an automatic clearing house (ACH) account number at a bank of the payee, account information for digital payment systems, digital wallet, etc.), a default donation amount, and/or the like. Account registering component 126 can store the information as one of payor accounts 120. In addition, payment management platform 102, in this regard, allows for a single point for signing up to initiate financial transactions over one or more social media platforms 110.

Where transaction-initiating component 132 initiates the transaction, when the payor, payee, and payment information is known, transaction processing component 134 can complete processing of the transaction (e.g., by contacting a financial institution 112 related to the payor and/or payee based on the payment information). In one example, transaction processing component 134 can wait for a grace period to expire after transaction-initiating component 132 initiates the transaction before completing processing of the transaction. For example, transaction-initiating component 132 may allow cancellation of the transaction during the grace period.

Moreover, in an example, initiating the transaction can include providing virtual dollars to the payor that may be used to donate to the payee. Thus, for example, transaction processing component 134 can process a transaction from the payee to the payment management platform 102 for the virtual dollars. In this example, transaction-initiating component 132 may initiate a transaction from the payor to the payee using the virtual dollars already purchased by the payor. Using virtual dollars in this regard may allow for further incentivizing financial transactions via the payment management platform 102. For example, the payment management platform 102 may offer the virtual dollars to a payor account not only by direct purchase of the virtual dollars, but also by other actions (e.g., as related to a specific payee account or otherwise). In a specific example, a payor account may receive virtual dollars for encouraging registering of other payor accounts to the payment management platform 102 (e.g., via social media content generated on the social media platform 110 using the associated initiator account 152), encouraging other payor accounts to initiate a financial transaction to the payee account (e.g., via social media content generated on the social media platform 110 using the associated initiator account 152), donating at or beyond one or more threshold amounts, etc. In another example, a payor account may use virtual dollars to purchase merchandise.

Moreover, in an example, receipt-generating component 136 may generate a receipt for the financial transaction. For example, the receipt can be generated for the payor account in the name of the payee account, and may be obtained by a device 106 or 108 accessing the payment management platform using the payor account, and/or may be provided to initiator account 152 via integration interface 158 on the social media platform 110, as described. In addition, dashboard providing component 138 may provide an interface for a payor or payee account, which can be accessed on payment management platform 102 by a device 106 or 108. For example, the dashboard interface may indicate a list of pending and/or completed transactions related to the payor or payee account. In addition, in this regard, the dashboard interface may provide a central place to manage and access information regarding financial transactions over a plurality of social media platforms 110. Thus, for example, the dashboard interface may list pending/completed transaction related to the payor or payee account, where each transaction may have been received over one or more of a plurality of social media platforms 110. Moreover, in this regard, the dashboard interface may aggregate information for one or more of the plurality of social media platforms to facilitate analysis of transactions over the one or more social media platforms (e.g., amounts sent or received via a given social media platform, etc.).

FIG. 2 illustrates an example method 200 for processing financial transactions based on social media platform content. Method 200 includes, at Block 202, receiving content from a social media platform relating to a payee account. Platform integrating component 128 can receive the content from the social media platform 110 relating to the payee account. For example, platform integrating component 128 can request the content from the social media platform 110 (e.g., via integration interface 158), which can include requesting content that relates to the payee account. As described, in an example, platform integrating component 128 can request content that relates to a receiver account 154 corresponding to the payee account (e.g., as indicated when registering the payee account with account registering component 126). In this regard, for example, method 200 can optionally include, at Block 204, determining the content relates to the payee account based at least in part on determining a receiver account in the social media platform related to the content. For example, platform integrating component 128 can determine the receiver account related to the content, and can accordingly request a portion of content 156 from the social media platform 110 that corresponds to the receiver account. In another example, platform integrating component 128 can request content that indicates a sequence of characters corresponding to the payee account (e.g., as indicated when registering the payee account with account registering component 126), which may include a name/nickname of an organization related to the payee account, a name of a product or donation campaign, etc. In any case, for example, social media platform can monitor content 156 based on the request by platform integrating component 128, and can provide related portions of content 156 thereto based on a request/response procedure, a publish/subscribe procedure (e.g., where the relevant content is provided as it is generated in the social media platform), etc. In another example, social media platform 110 may provide all content 156 (e.g., within a period of time) to platform integrating component 128, and content processing component 130 can filter for certain content related to the payee account, or at least relating to financial transactions, as described further herein.

Method 200 also includes, at Block 206, detecting a sequence of characters in the content indicating initiation of a financial transaction. Content processing component 130 can detect the sequence of characters in the content indicating initiation of the financial transaction. For example, content processing component 130 can detect a certain hashtag value or other sequence of characters, which may or may not include a dollar amount for the transaction and may or may not identify the payee account. In a specific example, described below, content processing component 130 may detect “#donate” in the content, which may indicate a financial transaction from one party (e.g., an initiator account in the social media platform 110) that authored the content to another party (e.g., which may be indicated in the “#donate” content, related to a page, wall, timeline, message, etc. on which the “#donate” content was posted, etc.). It is to be appreciated that the “#donate” content may include a copy of a post from another initiator account (e.g., a retweet). For example, the party initiating the financial transaction may be a donor donating to a donee account receiving money as part of the financial transaction. The donee may relate to a charitable organization, as described herein, or may more generally relate to substantially any account in the social media platform 110 (e.g., allowing peer-to-peer or other more general transferring of money by using the sequence of characters). For example, the payee may advertise goods or services for sale (e.g., event tickets), which may be via a page, post, or other content generated on the social media platform 110, and the payor account may specify the sequence of characters to initiate payment to the payee for the advertised goods or services.

Moreover, in an example, the donee may relate to an organization or an individual campaigning for another organization. In a specific example, a restaurant may campaign for a charitable organization by offering a promotion to payees that donate to the charitable organization by initiating the financial transaction to the restaurant (e.g., using “#donate” or other sequence of characters on a wall, timeline, page, etc. of the restaurant). In this example, the restaurant receives the donations via the payment management platform 102. Accordingly, the restaurant can provide the donations to the charitable organization via the payment management platform 102 or otherwise. In another example, payment management platform 102 may allow the donee organization to specify that donations for the campaign are to go to the charitable organization directly rather than to the donee organization.

In other specific examples, specific sequences of characters in this regard may include “#bid” to indicate a bid by a potential payor for an item advertised for auction on the social media platform 110, “#invest” to trigger an investment (e.g., a financial transaction to a brokerage to invest in a stock, bond, mutual fund, etc.), “#recruit” to hire and/or pay a recruiter, “#contribute” to trigger a contribution to a political campaign, etc. Moreover, for example, sequences of characters can be provided to indicate periodic (e.g., monthly, annual, etc.) financial transactions.

In yet another example, interactions offered by the social media platform 110 may be used to trigger the financial transaction (e.g., initiator account 152 activating a like button, initiator account 152 sharing content on its own wall, initiator account 152 retweeting or otherwise republishing content from another initiator account in the social media platform 110, etc.). In one specific example, where initiator account 152 activates a like button on a donation campaign interface of a receiver account 154, this can similarly be detected by content processing component 130 in content received from platform integrating component 128, which may automatically cause trans action-initiating component 132 to initiate a financial transaction to the payee account associated with the receiver account 154 for a certain amount, which may be configured by the payor account related to initiator account 152, the payee account, etc.

As described, content processing component 130 may additionally or alternatively attempt to detect a “$” or other currency symbol after or otherwise near the sequence of characters to determine an amount of the financial transaction. Alternatively, content processing component 130 may determine a default amount for the financial transaction (e.g., as specified in a payor account related to an initiator account 152 associated with the content, if identifiable in the payment management platform, as specified in related content posted by the receiver account 154 for the product or donation campaign, etc.). In another example, content processing component 130 may prompt for a donation amount (e.g., via interaction with the social media platform 110, via interfaces of the payment management platform 102, etc). In addition, content processing component 130 may attempt to detect a “@” or other symbol after or otherwise near the sequence of characters to indicate a specification of the payee account. This may facilitate a financial transaction to the payee account where the sequence of characters is posted on a general feed of the payor's initiator account on the social media platform 110 (e.g., and not on a page, wall, timeline, etc. of the payee's receiver account 154).

Method 200 also includes, at Block 208, determining an initiator account on the social media platform that is associated with the sequence of characters. Content processing component 130 can determine the initiator account 152 on the social media platform 110 that is associated with the sequence of characters. For example, content processing component 130 can determine the initiator account 152 as an author of the sequence of characters within the content. For example, the content received by platform integrating component 128 may specify an author of each item of content (e.g., along with one or more other parameters), or the author may otherwise be determined based on parameters or information in characters near the detected sequence of characters within the content (e.g., based on detecting an authoring account field before the sequence of characters, etc.).

Method 200 also includes, at Block 210, initiating the financial transaction based at least in part on the initiator account, detecting the sequence of characters, and the payee account. Transaction-initiating component 132 can initiate the financial transaction based at least in part on the initiator account 152, detecting the sequence of characters, and the payee account. For example, transaction-initiating component 132 may determine whether the initiator account 152 has a corresponding payor account in payor accounts 120 of the payment management platform 102. For example, a payor account may have been registered and linked to the initiator account 152. Thus, in this case, transaction-initiating component 132 can initiate the financial transaction based on payment information specified for the payor account (e.g., as specified during registration of the payor account with account registering component 126). As such, initiating the financial transaction at Block 210 may optionally include, at Block 212, initiating payment from the payor account associated with the initiator account in a payment management platform to the payee account.

If transaction-initiating component 132 cannot determine a payor account associated with the initiator account, transaction-initiating component 132 can determine to prompt the initiator account to register a payor account, as described, or can otherwise prompt for payment information over the social media platform 110 (e.g., via integration interface 158). For example, the prompt may include a response in the content that included the sequence of characters, a private or pop-up message to the initiator account 152, a redirection of a current window on a device 106 or 108 using the initiator account 152 to the registration interface provided by account registering component 126 and/or to a general donation page for donating without registering, etc. In an example, initiating the transaction may include preauthorizing the transaction using payment information associated with the payor account. In any case, indicating the transaction may include storing a portion of information related to the initiator account, payor account, payee account, transaction amount, etc., in transactions 124 for subsequent processing by transaction processing component 134.

Moreover, in an example, transaction-initiating component 132 may compute an individual fundraising score for a given payor account (e.g., as related to a certain payee and/or payee's campaign, etc.). For example, the individual fundraising score can capture, analyze, and present a quantifiable network effect score for each payor (e.g., donor) to a payee (e.g., charitable organization), which can include a score computed based on donations received as a result of a donation from the payor account. For example, the received donations can include those received from social media platform 110 friend accounts of the payor account that have donated after the payor, that indicate the payor account in social media content that includes the donation, that generate the social media content that includes the donation as a comment to a post by the payor, or that otherwise can be traced back to the payor account, etc.). For example, the score can capture the amount and/or number of donations received as a result of the payor's initial donation. Accordingly, this score can assist in identifying the most influential members of a payee's social network (e.g., those payors who have helped contribute to a payee's campaign or general message virality outside of the payee's network). In one example, the payee may post this individual fundraising score on the social media platform 110 (e.g., via receiving one or more scores for one or more payors or related initiator accounts from platform integrating component 128).

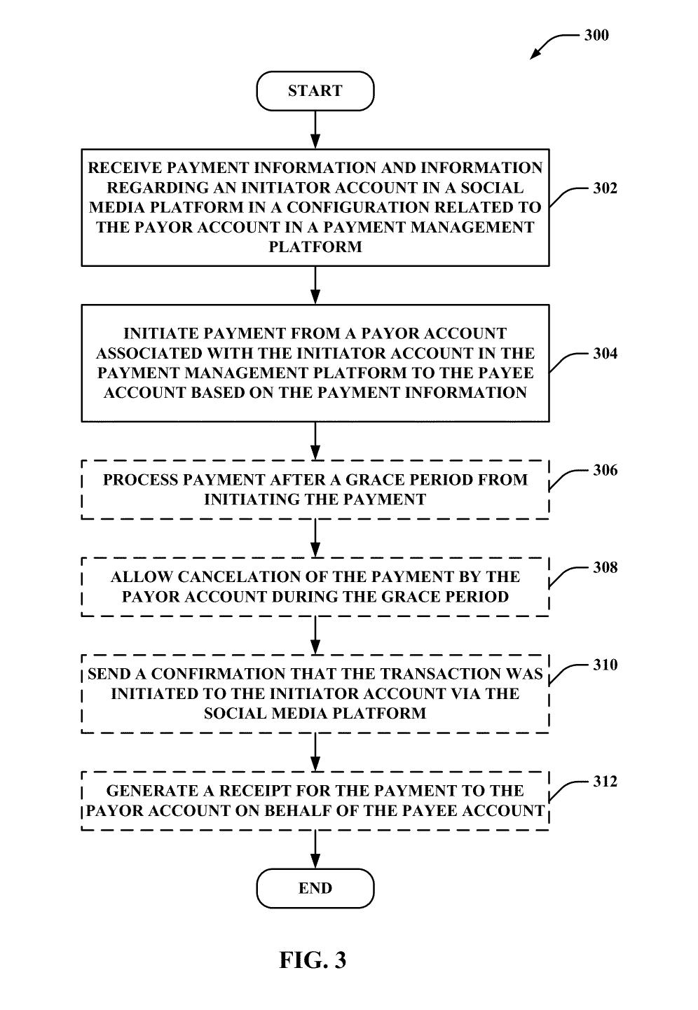

FIG. 3 illustrates an example method 300 for initiating the payment from the payor account to the payee account. Method 300 includes, at Block 302, receiving payment information and information regarding an initiator account in a social media platform in a configuration related to the payor account in a payment management platform. Account registering component 126 can receive the payment information and information regarding the initiator account 152 in the social media platform 110 in the configuration related to the payor account in the payment management platform 102. As described, this can be part of a registration of the payor account performed by the account registering component 126 communicating with a device 106 or 108, as described herein. Moreover, as described, the payment information can relate to one or more account numbers (e.g., a credit card number, ACH information for withdrawing funds at a bank, account information for digital payment systems, digital wallets, etc., and/or the like).

Method 300 also includes, at Block 304, initiating payment from a payor account associated with the initiator account in the payment management platform to the payee account based on the payment information. Transaction-initiating component 132 can initiate payment from the payor account associated with the initiator account 152 (e.g., in the payor account information) in the payment management platform 102 to the payee account based on the payment information. As described, this can include storing information regarding the transaction in transactions 124 for subsequent processing, preauthorizing a charge based on payment information of the payor account, etc. In one example, the payor account may be a temporary payor account that can be associated with the initiator account 152 (e.g., where a payor account corresponding to the initiator account 152 does not exist in the payment management platform). In this example, the payment information may be otherwise obtained from the initiator account 152 (e.g., by prompting the initiator account 152 via social media platform 110, directing or redirecting the initiator account 152 to a payment page to enter payment information, etc.). In addition, in an example, the initiator account 152 may be prompted for additional information regarding the payment (e.g., periodicity as a one-time, monthly, annual, etc. payment, etc.)

Method 300 can optionally include, at Block 306, processing payment after a grace period from initiating the payment. Transaction processing component 134 may process the payment after the grace period from initiating the payment. For example, transaction processing component 134 may obtain payment information from transactions 124, and may determine which transactions have an expired grace period (e.g., based on a grace period time specified in the transaction, based on comparing a time of the transaction to the time plus a grace period value, etc.). Transaction processing component 134 may accordingly process transactions with an expired grace period (e.g., periodically, upon detecting expiration of a grace period, etc.). Processing the transaction may include transaction processing component 134 communicating with one or more financial institutions 112 based on the payment information to effectuate the payment from a financial account of the payor account to a financial account of the payee account. As described, the financial institutions 112 may relate to banks, digital payment systems, digital wallets, etc.

Method 300 may also optionally include, at Block 308, allowing cancellation of the payment by the payor account during the grace period. Transaction-initiating component 132 may allow the payor account to cancel the transaction, which may occur by a device 106 or 108 accessing a dashboard on the payment management platform 102 generated by dashboard providing component 138, which is described further herein. For example, where a transaction is canceled, transaction-initiating component 132 may remove the transaction information from transactions 124.

Method 300 may also optionally include, at Block 310, sending a confirmation that the transaction was initiated to the initiator account via the social media platform. Transaction-initiating component 132 can send the confirmation that the transaction was initiated to the initiator account 152 via the social media platform 110. For example, transaction-initiating component 132 can send the confirmation in content related to the content from which the sequence of characters is detected (e.g., on a page, wall, timeline, message, etc. where the initiator account 152 authored the content), in a private or pop-up message to the initiator account 152, etc. via integration interface 158. As described, in an example, where a payor account for the initiator account 152 is not located in payment management platform 102, transaction-initiating component 132 can include a link in the confirmation, where the link is to a registration interface provided by account registering component 126.

Method 300 may also optionally include, at Block 312, generating a receipt for the payment to the payor account on behalf of the payee account. For example, receipt-generating component 136 may generate the receipt for the payment to the payor account on behalf of the payee account. In one example, the payor account can request generation of the receipt via an interface provided by the payment management platform 102, such as the payor dashboard provided by dashboard providing component 138. In another example, receipt-generating component 136 may provide the receipt to the initiator account 152 via integration interface 158 (e.g., in a private or pop-up message) based on transaction processing component 134 processing the transaction.

In one specific example, described further herein, account registering component 126 allows registration of charitable organization payee accounts, and donor payor accounts. In this example, the charitable organization payee accounts can be correlated with charitable organization receiver accounts 154 in the social media platform, and the donor payor accounts with initiator accounts 152. Thus, for example, a receiver account 154 related to a charitable organization can launch a donation campaign on the social media platform 110, which can include generating a page for the campaign that is viewable and modifiable by one or more other accounts in the social media platform 110 (e.g., accounts corresponding to social connections, e.g., “friends” of the charitable organization or campaign, substantially any account, etc.). The page can be created and stored in content 156, for example. Platform integrating component 128 can request a portion of content 156 relating to the page (e.g., posts on the page, comments on the posts, etc.), which integration interface 158 can provide to the platform integrating component 128 in substantially real-time as content is generated on the page, in response to a request, etc. In another example, platform integrating component 128 can request a portion of the content 156 which includes the sequence of characters indicating the financial transaction.

In this example, content processing component 130 can attempt to detect a sequence of characters in the content that indicates a desire to make a donation to the campaign. In a specific example, content processing component 130 can attempt to detect posts, comments, etc. that include “#donate” in the content. Thus, where an initiator account 152 posts on the campaign page “I #donate $20,” for example, integration interface 158 can provide the post to platform integrating component 128, and content processing component 130 can detect the “#donate” sequence of characters in the post. Content processing component 130 can then determine the initiator account 152 associated with the post, and transaction-initiating component 132 can determine whether one of payor accounts 120 is associated with the initiator account 152. In addition, content processing component 130 can determine the donation amount based on the “$” and/or based on the numeric characters following “#donate.” In any case, for example, transaction-initiating component 132 can initiate a payment of $20 from the payor account the payee account associated with the charitable organization linked to the receiver account 154. In another example, where content processing component 130 cannot determine a donation amount, transaction-initiating component 132 can initiate a payment of a default amount (e.g., specified in the payor account information) from the payor to the payee.

In yet another example, where transaction-initiating component 132 cannot determine a payor account associated with the initiator account 152, transaction-initiating component 132 can provide a link to a registration page to the initiator account 152 in the social media platform 110 (e.g., by using integration interface 158 to send a reply, message, etc. to the initiator account 152). Transaction-initiating component 132 may store the transaction in transactions 124 pending registration for a payor account corresponding to the initiator account 152.

In another example, initiator account 152 may initiate a donation to the receiver account 154 without posting content to a page of the receiver account 154. For example, initiator account 152 may generate content on its page or as a general message that may specify a name or nickname registered for the payee account of the charitable organization. For example, initiator account 152 may generate a message “I #donate $20 to RedCross,” where “RedCross” can be associated with the payee account in information received during registration of the payee account. In this example, content processing component 130 can further determine that the sequence of characters relates to the payee account based at least in part on detecting “RedCross” in the received content, and transaction-initiating component 132 can accordingly initiate the transaction from the initiator's payor account to the payee account (or can otherwise prompt the initiator account 152 to register, etc.). In this regard, the charitable organization may not have a receiver account 154 on social media platform 110 at all, in this example.

In any case, for example, receipt-generating component 136 can generate receipts for the donor payor account on behalf of the charitable organization associated with the payee account (e.g., on uploaded or generated letterhead for the charitable organization). Moreover, for example, dashboard providing component 138 can provide the payee account with a dashboard of pending and/or completed donations, which may be broken down by campaign page, social media platform, etc. Dashboard providing component 138 can also provide the payor account with a dashboard of pending and/or completed donations, an option to cancel pending donations, etc., as described further herein. In addition, social media platform 110 may allow the initiator account 152 to specify a level of publicity or visibility for the social media content that includes the post (e.g., show to friends, members of friends' networks, e.g., to the nth degree, everyone, etc.).

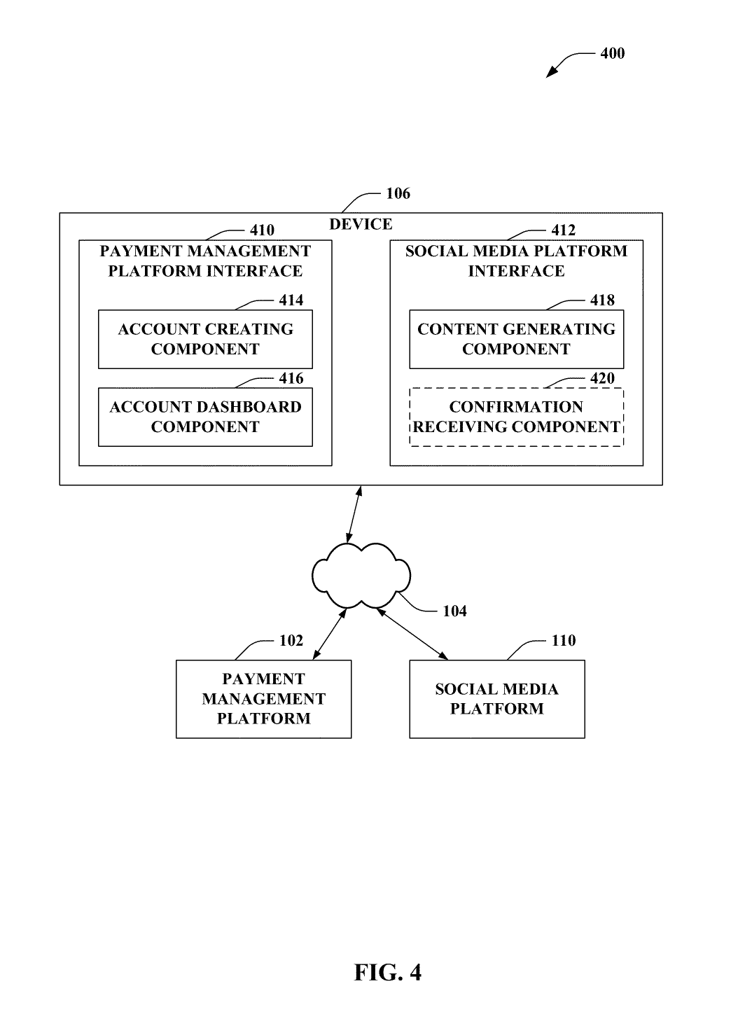

FIG. 4 illustrates an example system 400 for communicating with a payment management platform 102 and/or a social media platform 110 over a network 104. Device 106 includes a payment management platform interface 410 for communicating with the payment management platform 102, and a social media platform interface 412 for communicating with the social media platform. In either case, for example, the interfaces 410 and 412 may include interactive webpages and related data received from payment management platform 102 and/or social media platform 110, one or more applications provided by and able to communicate with payment management platform 102 and/or social media platform 110, etc.

Payment management platform interface 410 may include an account creating component 414 for creating an account with the payment management platform, and an account dashboard component 416 for viewing account details from the payment management platform 102. Social media platform interface 412 may include a content generating component 418 for viewing and/or generating content from/to the social media platform 110, and/or a confirmation receiving component 420 for receiving confirmation of a financial transaction related to payment management platform 102.

According to an example, as described, account creating component 414 can facilitate creating an account with payment management platform 102, which may include receiving an interface for creating the account from the payment management platform 102. For example, the interface may include a plurality of fields to fill in creating the account, such as user name, social media account information, payment information, etc. The information can be input, and account creating component 414 can provide the information to payment management platform 102 to create the account. Subsequently, account dashboard component 416 can receive and display an account dashboard for the created account, as described. It is to be appreciated that account creating component 414 can be utilized to change account information, delete an account, etc. Once the account is created, where the related social media account posts content for initiating financial transaction to social media platform 110, payment management platform 102 can automatically initiate the financial transactions, as described herein.

For example, content generating component 418 can generate content on the social media platform 110. Social media platform 110 can forward at least a portion of the content to the payment management platform 102 (e.g., where the content relates to a payee account at the payment management platform 102, an associated receiver account on the social media platform 110, a desire to initiate a financial transaction, etc.). Where content generating component 418 generates content to initiate a financial transaction, payment management platform 102 can accordingly initiate the financial transaction, and may communicate a confirmation to the social media account being utilized by device 106, and confirmation receiving component 420 can accordingly receive the confirmation.

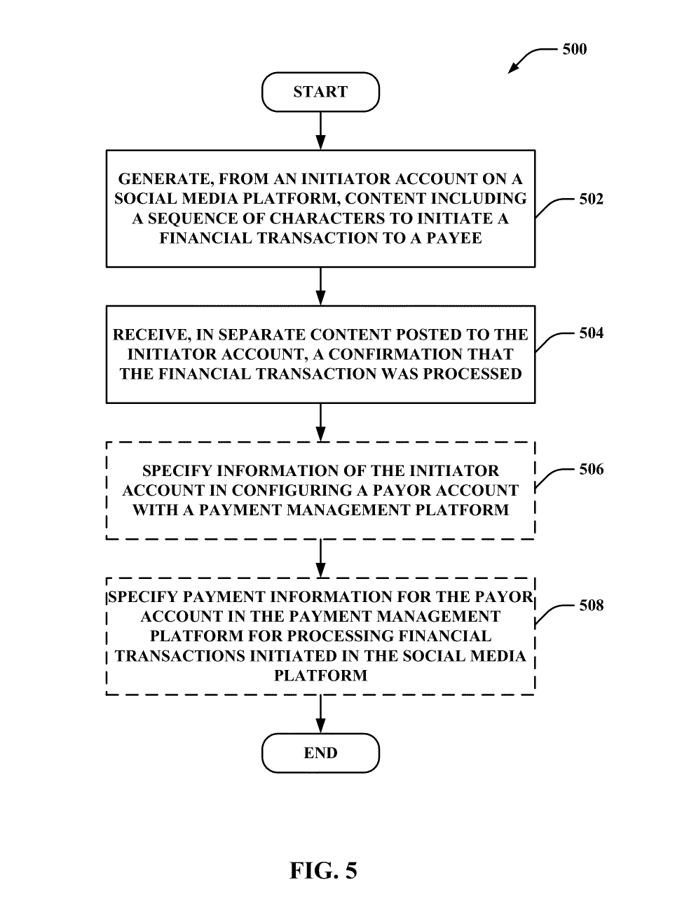

FIG. 5 illustrates an example method 500 for generating content on a social media platform to initiate a financial transaction. Method 500 includes, at Block 502, generating, from an initiator account on a social media platform, content including a sequence of characters to initiate a financial transaction to a payee. For example, device 106 can be logged in to the social media platform 110 as the initiator account, and content generating component 418 can generate content on the social media platform 110 that includes a sequence of characters to initiate the financial transaction to the payee. As described, for example, this can include generating content on a page, wall, timeline, message, etc. of a receiver account of the payee on the social media platform, generating content that specifies the payee by name, nickname, receiver account, etc., and/or the like. In addition, the content can specify the sequence of characters related to a financial transaction (e.g., “#donate”) and may or may not include a payment amount.

As described, the payment management platform 102 can process such content received from the social media platform 110 to effectuate the financial transaction, and may send a confirmation of the transaction to the initiator account via social media platform 110. Thus, method 500 may also include, at Block 504, receiving, in separate content posted to the initiator account, a confirmation that the financial transaction was processed. With device 106 logged in as the initiator account, confirmation receiving component 420 can receive, in separate content posted to the initiator account, a confirmation that the financial transaction was processed. For example, the confirmation may include another post (e.g., a reply post to the initiator account) on the page on which the initiator account generated the content the initiated the financial transaction, a pop-up or private message to the initiator account, etc.

Moreover, method 500 may optionally include, at Block 506, specifying information of the initiator account in configuring a payor account with a payment management platform, and/or, at Block 508, specifying payment information for the payor account in the payment management platform for processing financial transactions initiated in the social media platform. Account creating component 414 can specify the information of the initiator account in configuring the payor account with the payment management platform 102 and/or may specify payment information for the payor account in the payment management platform 102 for processing financial transactions initiated in the social media platform 110, as described.

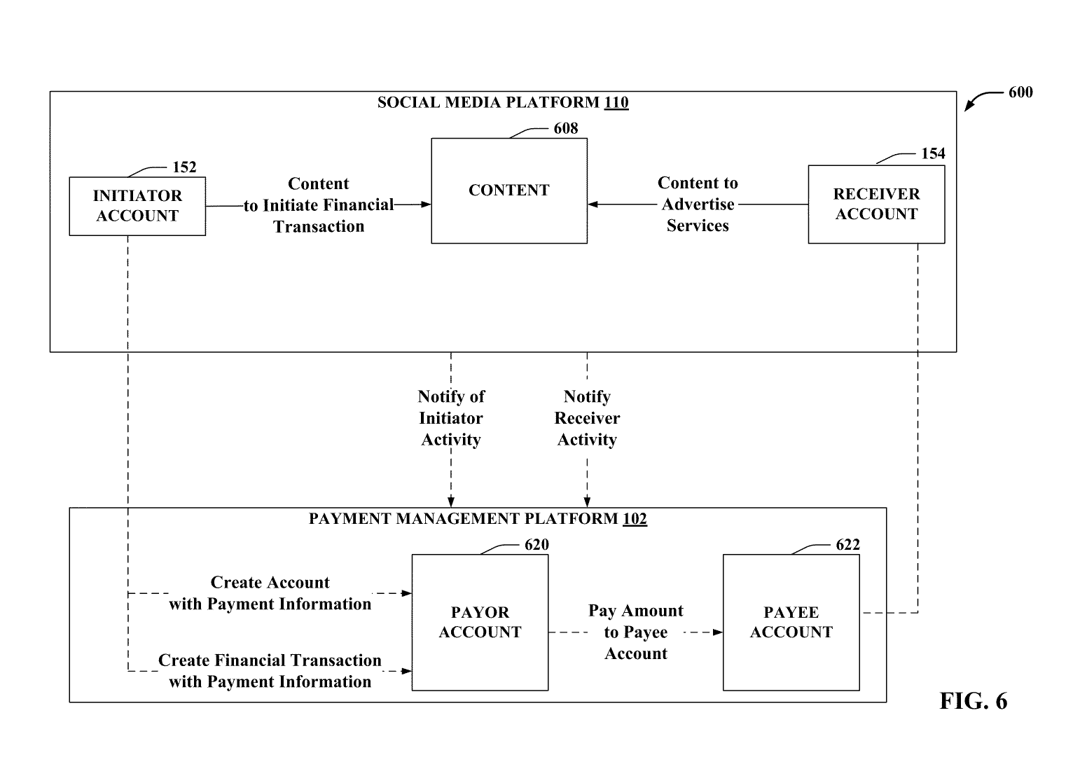

FIG. 6 illustrates an example flowchart 600 of data between a social media platform 110 and payment management platform 102, as described herein. Social media platform 110 includes an initiator account 152, a receiver account 154, and content 608. For example, the receiver account 154 can create content 608 to advertise services (e.g., products, donation campaigns, etc.). The content can include a page on the social media platform 110, a post on a page, a comment on a post, etc. Initiator account 152 can generate content to initiate a financial transaction, which may relate to content generated by the receiver account 154 or the receiver account 154 generally. The content generated by initiator account 152 can correspond to a post on content generated by the receiver account 154, a comment on content generated by the receiver account 154, a share of content generated by the receiver account 154, a post, comment, message, etc. that indicates the receiver account 154, and/or the like. Initiator account 152 can also create a payor account 620 on the payment management platform 102, which may be linked to the initiator account 152. In one example, the initiator account 152 can login to the payment management platform 102 using the social media account.

Social media platform 110 can notify the payment management platform 102 of initiator account activity and/or receiver account activity, etc. In one example, payment management platform 102 may begin to monitor content related to content generated by the receiver account 154 based at least in part on receiving a notification of the content generated by receiver account 154 from the social media platform 110. In addition, in this regard, where initiator account 152 generates the content to initiate the financial transaction, based on notification thereof to the payment management platform 102, a financial transaction with payment information can be created for the initiator account 152 activity and linked to payor account 620. In any case, payor account 620 can pay an amount to the payee account 622 linked to the receiver account 154 based on the initiated financial transaction.

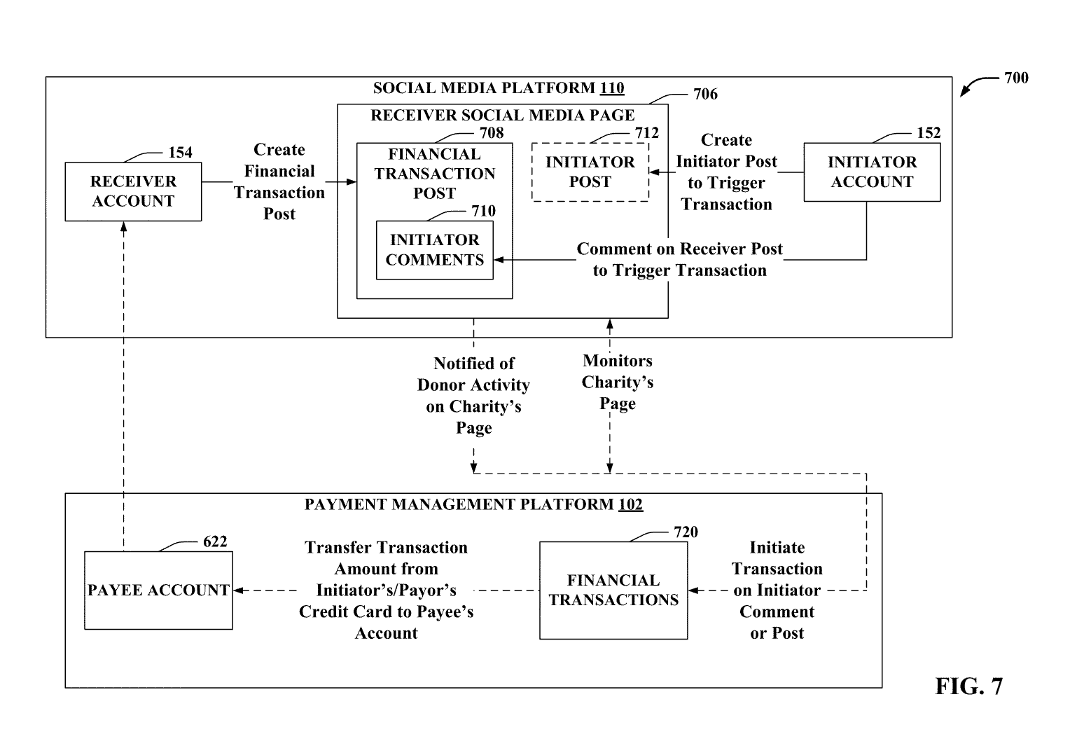

FIG. 7 illustrates another example flowchart 700 of data between a social media platform 110 and payment management platform 102, as described herein. Social media platform 110 includes an initiator account 152, a receiver account 154, and a receiver social media page 706. For example, the receiver social media page may advertise services of the receiver account (e.g., products, donation campaigns, etc.) for which transactions may be initiated. In one example, receiver account 154 may also generate a financial transaction post 708 on the social media page 706. In an example, social media platform 110 may notify the payment management platform 102 of the social media page 706, the financial transaction post 708, and/or the like, which the payment management platform 102 can then monitor for additional content related to financial transactions.

In an example, initiator account 152 can comment 710 on the financial transaction post to trigger a transaction (e.g., the comment can include the sequence of characters to initiate the financial transaction). In another example, initiator account 152 may generate an initiator post 712 on the receiver social media page 706 to trigger the transaction (e.g., the comment can include the sequence of characters to initiate the financial transaction). In either case, the payment management platform 102 can be notified of the activity on the receiver social media page 706, and may accordingly initiate a transaction in financial transactions 720 based on detecting the sequence of characters in the initiator comments 710 and/or the initiator post 712. This can cause a transfer of a transaction amount from the initiator to the payee account 622, where the payee account 622 is linked to the receiver account 154. For example, the transfer of the transaction amount may be initiated from a payor account related to the initiator account 152, based on payment information specified by the initiator account 152, etc.

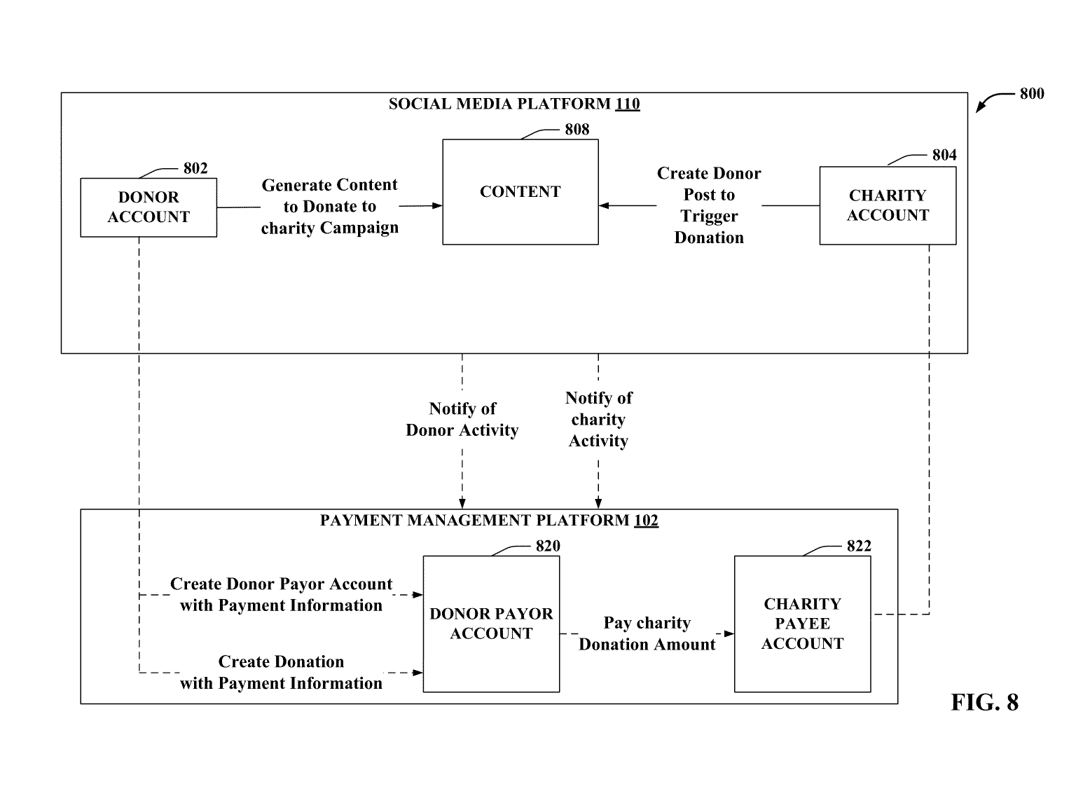

FIGS. 8-12 are described below in specific reference to charitable organizations that can receive donations from donors using specific characters in social media content. The paragraphs that follow and those that described FIGS. 8-12 present one specific and non-limiting example of the subject matter described herein. According to some of the examples, a charitable organization may participate actively or passively in receipt of charitable monetary donations from users of a social media platform (e.g., a social network). On one hand, a charitable organization may participate actively in the receipt of charitable monetary donations from users of a social network by taking affirmative steps to alert users of the social network of the charitable organization and to solicit charitable donations from users of the social network for the charitable organization. One manner in which a charitable organization could participate actively in the receipt of charitable monetary donations from users of a social network is through a campaign-based model. Utilizing a campaign-based model, the charitable organization may participate actively in the receipt of charitable monetary donations from users of a social network by organizing a campaign-based approach to actively solicit charitable donations from users of a social network within the social networking environment. If a charitable organization utilizes a campaign-based approach to actively solicit charitable monetary donations from users of a social network, the charitable organization may choose to set a monetary goal that can serve as a benchmark for the amount of money that the charitable organization hopes to solicit from users of the social network and that monetary goal may be tied to a specific project that the charitable organization wishes to generate funds to help the charitable organization undertake. After setting a monetary goal based on the level of funding required for a specific project, the charitable organization may directly solicit monetary donations from users of the social network to help the charitable organization reach the established goal. When utilizing a campaign-based approach, a charitable organization may identify certain users of the social network to serve as ambassadors who may provide testimonial and/or be specifically responsible for helping to inform other users of the social networking environment about the charitable organization's fundraising efforts. The campaigned-based model is just one example of the methods that a charitable organization could take to actively solicit donations from users of a social network. Alternatively, the charitable organization may participate passively in the receipt of charitable monetary donations from users of a social network. A charitable organization may participate passively by receiving a charitable monetary donation from a user of a social network and accepting the charitable donation made by the user of the social network without taking any affirmative steps to solicit that monetary donation.

According to some of the various examples, users of a social network may receive information about a charitable organization through the social networking environment, make a monetary donation to the charitable organization through the social networking environment, and allow other users of the social networking environment to view information regarding the charitable monetary donation that the user of the social network made to the charitable organization. For example, allowing the other users to view the information may include specifying visibility of the donation content for different users and/or groups of users in the social media platform, specifying social media accounts (e.g., of friends) within the donation social media content to call out certain friends to encourage donation to the charitable organization, or using other settings allowed by the social media platform, etc. By allowing other users of the social network to view information regarding the charitable monetary donation made by the user of the social network to a charitable organization, the user of the social network that made the charitable monetary donation to the charitable organization may cause other users of the social network to also make a charitable donation to the charitable organization and thus may participate actively. Some examples allow information regarding the charitable monetary donation to a charitable organization made by a user of the social network to be made publically available to other users of the social network—either to other users of the social network who are connected to the user of the social network or to a broader group of users of the social network—within the social networking environment. Users of the social networking environment who view information regarding the charitable monetary donation to the charitable organization made by the user of the social network may be able to make a charitable donation without leaving the portion of the social network where information regarding the monetary donation made by the user of the social network was viewed. This is just one example through which a user of a social network could participate actively. A user of a social network who made a charitable monetary donation to a charitable organization within the social networking environment may take an even more active role by encouraging other users of the social network who are connected to the user of the social network or to a broader group of users of the social network to make a donation to that charitable organization. One example of a manner in which the user of a social network may participate actively is by visiting the social network system page of a charitable organization within the social networking environment, making a donation to the charitable organization through the social networking environment, informing his or her connections within the social networking environment of the charitable monetary donation that the user of the social network made to the charitable organization, and challenging those connections to also make a charitable monetary donation to the charitable organization within the social networking environment. For example, a user of a social networking site who made a monetary donation to a charitable organization through the social networking environment may allow information regarding the monetary donation to appear on his or her social network site newsfeed and may also modify the information posted on his or her newsfeed to actively encourage his or her connections within the social network or another subset of users of the social network to also make a monetary donation to the charitable organization through the social networking environment. For instance, the user of the social network who made a charitable monetary donation to a charitable organization through the social networking environment may challenge other users of the social networking environment to match his or her monetary donation by also making a monetary donation to the charitable organization through the social networking environment.

FIG. 8 illustrates an example flowchart 800 of data between a social media platform 110 and payment management platform 102, as described herein. The social media platform (e.g., social media networking site) may be run by a person or entity that provides social networking services to users of the social network, such as communication services, dating services, company intranets, online games, combinations thereof, and/or the like. The social network provider may host a website, for example, that allows users of the social networking site to communicate with other users of the social networking site through a communication network using one or more devices. Some examples of the social networking environment may only allow users of the social network to communicate directly with a subset of the users of the social network, such as those to whom they are connected to directly or connected to through another user—either a person or entity—of the social network. Users of the social network may access the social network through various mechanisms including, among other mechanisms, through a computer or a smart phone. In various examples, the communication network may include, among other things, a local area network, a wide area network, a wireless network, an intranet, the Internet, a combination thereof, and/or the like.

The user of a social network may be a person or entity that is a registered user of a social networking site. A registered user of a social networking site may be an individual who is allowed to use some or all of the features of the social networking site by virtue of membership. To be a registered user of a social networking site, a person or entity may have gone through the registration process required by the social networking site for that person or entity to become a registered user and thus use some or all features of the social networking site. For example, a person may become a registered user of the social networking site by creating an account, which may require an individual to fill out an online form that includes the individual's name, date of birth, gender, and email address. Once the individual fills out this information, as part of the registration process, the individual may receive an email confirmation that they must click on to finalize the creation of their account and thus become a registered user of the social networking site. After an individual registers with the social networking site, the social networking site may give that individual the ability to create a profile and connect with other users of the social networking site within the social networking environment.

The user social networking site information may include information regarding a user of a social network that allows one user of a social networking site to be distinguished from other users of a social networking site within the social networking environment. For example, a user of the social network may be given a specific username that identifies the individual within the social networking environment and distinguishes one user of the social networking site from other users of the social networking site.

The payment management platform, as described herein, may relate to a payment processing organization that may be an organization that registers users of a social network through an Internet website, allowing users of the social network to make charitable monetary donations to charitable organizations, non-registered organizations, donation campaigns for business that are related or unrelated to the business, etc. through the social networking environment, as described in examples above. The term payment processing organization may be used herein to refer to the payment management platform or at least the organization that provides the payment management platform. When a user of a social network visits the Internet website of a payment processing organization, the user of the social network may be given the option of setting up an account with the payment processing organization. If the user of the social network sets up an account with the payment processing organization, the user of the social network may be required to provide the payment processing organization with specific information, including credit card information and user social networking site information, which the payment processing organization may use to access the individual's social networking environment. When a user of a social network signs up with the payment processing organization, the payment processing organization may create an account that contains information provided by the user of the social network. Credit card information for the user of the social network may be transmitted to and stored by a secure third-party.

A user of a social network may be prompted to visit the Internet website of the payment processing organization in a variety of manners. A user of a social network may visit the Internet website of the payment processing organization and register with that payment processing organization before ever indicating that he or she wishes to make a charitable monetary donation to a charitable organization via the social networking environment. Alternatively, a user of a social network may be prompted to visit the Internet website of the payment processing organization and register with that payment processing organization, after the user of a social network has indicated that he or she wishes to make a charitable monetary donation to a charitable organization via the social networking environment, as described.

The user of the payment processing organization may be an individual who is a registered user of the payment processing organization. To be a registered user of the payment processing organization, an individual may have gone through the registration process required by the payment processing organization for that individual to become a registered user and thus be able to use some or all features of the payment processing organization. This may involve visiting the Internet website of the payment processing organization and creating an account with the payment processing organization. Creating an account with the payment processing organization may require an individual to fill out an online form that includes information about the individual, such as the individual's name, date of birth, credit card information, mailing address, and email address, as well as, user social networking site information. User social networking site information may be provided as part of the registration process because by virtue of registering, the user of the payment processing organization may provide that payment processing organization with access to his or her social networking environment.

For example, an Application Program Interface (API) may be used to access databases by specifying the manner in which certain software components should interact with each other and, as such, an API may allow for the collection of information from a social networking environment by the for profit organization, such as the platform integrating component 128, integration interface 158, etc., described herein. An API may allow for the collection of information from a social networking environment, provided that the API has access to the portion of a social networking environment where the information is located.

Specified characters are characters that a user of a social network can use within a social networking environment and that may be identified and/or collected by an API by virtue of their use within a social networking environment. For example, a user of a social network may be able to express his or her desire to make a monetary charitable donation to a charitable organization through the social networking environment by utilizing specified characters within that social networking environment and those characters may be identified by the API, provided that the API has access to the area in the social networking environment where the specified characters are located.

An API may identify and/or collect information posted by a user of a social network in a social networking environment in either a direct or indirect manner. An API may identify and/or collect information directly from a user of a social network, if the user of the social network is also a registered user of the payment processing organization who has provided that payment processing organization with access to his or her social networking environment. An API may be used by the payment processing organization to directly identify and/or collect information from the social networking environment of a user of a social network who is also a registered user of the payment processing organization and has provided that payment processing organization with access to his or her user social networking site information, allowing the payment processing organization to access his or her social networking environment. After a payment processing organization gains access to a registered user of the payment processing organization's social networking environment, the payment processing organization may utilize an API to identify and/or collect information from the registered user of the payment processing organization's social networking environment. By identifying and/or collecting such information, the payment processing organization may be alerted to the presence of certain information, including the use of specified characters in the social networking environment by the registered user of the payment processing organization expressing his or her desire to make a monetary charitable donation to a charitable organization via the social networking environment. Once a user of a social network has registered with the payment processing organization and provided the payment processing organization with access to his or her social networking environment, the user of the social networking site may be able to make donations to any charitable organization via the social networking environment without ever leaving the social networking environment or even accessing a social network system user, non-person entity, content item, group, or social network system page.

An API may also identify and/or collect information directly from the social networking environment of a charitable organization, if the charitable organization is also a registered user of the payment processing organization and the payment processing organization has been provided with access to the social networking environment of the charitable organization. An API may be used by the payment processing organization to directly identify and/or collect information from the social networking environment of the charitable organization that is also registered with the payment processing organization and has provided that payment processing organization with access to its social networking site information, allowing the payment processing organization to access the social networking environment of the charitable organization. After the payment processing organization gains access to the social networking environment of the charitable organization, the payment processing organization may utilize an API to identify and/or collect information from the charitable organization's social networking environment. By identifying and/or collecting such information, the payment processing organization may be alerted to the presence of certain information regarding the desire of users of the social networking site to make a monetary charitable donation to that charitable organization via the social networking environment. Once a charitable organization has registered with the payment processing organization and provided the payment processing organization with access to the social networking environment of the charitable organization, users of the social networking site may be able to make donations to that charitable organization via the social networking environment by posting information in the social networking environment of the charitable organization regardless of whether or not the user of the social networking site has previously registered with the payment processing organization.

An API may also identify and/or collect information from a user of a social network indirectly, if a user of a social network that is not registered as a user of the payment processing organization uses specified characters in a social networking environment and those specified characters are visible in an social networking environment that the API of the payment processing organization can access, such as the social networking environment of a registered user of the payment processing organization or another social network system user, non-person entity, content item, group, or social network system page that the payment processing organization can access. The payment processing organization's API may be able to identify and/or collect information posted by a user of a social network that is not registered with the payment processing organization in this manner because the API can still identify and/or collect the specified characters through a social networking environment to which it has access.

An API may also identify and/or collect information from a user of a social network indirectly, if a user of a social network that is not registered as a user of the payment processing organization posts information in the social networking environment of a charitable organization that has also registered with the payment processing organization and allowed the payment processing organization to access its social networking environment, regardless of whether or not specified characters are utilized. The payment processing organization's API may be able to identify and/or collect information posted by a user of a social network that is not registered with the payment processing organization in this manner because the API can still identify and/or collect the information through the social networking environment to which it has access—the social networking environment of the charitable organization that has also registered with the payment processing organization and provided the payment processing organization with access to its social networking environment—by virtue of the connection of the posted information to other information regarding monetary charitable donations to the charitable organization.

For example, if a user of the social networking site who had previously registered with the payment processing organization expressed a desire to make a donation to a charitable organization via the social networking environment by using specified characters in the social networking environment then that information could be identified and/or collected up by the payment processing organization's API. If a user of the social networking site expressed a desire to make a donation to a charitable organization via the social networking environment by posting information in the social networking environment of a charitable organization that had also registered with the payment processing organization and provided the payment processing organization with access to its social networking environment then that charitable monetary donation could be identified and/or collected by the payment processing organization's API, regardless of whether or not the user of the social network had previously registered with the payment processing organization and provided the payment processing organization with access to his or her social networking environment. Additionally, if a user of the social networking site chooses to post information regarding the charitable monetary donation that he or she made to the charitable organization via the social networking environment on his or her wall and/or newsfeed, thereby allowing information regarding the donation to be visible to other users of the social networking site, and another user of the social networking site, in response to that information, posted specified characters in the social networking environment indicating his or her desire to make a charitable monetary donation to the charitable organization via the social networking environment, the API could identify and/or this information by way of the social networking environment of the user of the social network that was registered with the payment processing organization.

When a user of a social network registers with a payment processing organization, he or she may be provided with information regarding the specific characters that may be use in a social networking environment—that may in turn be picked up by the API of the payment processing organization—to alert the payment processing organization that the user of the social network wishes to make a donation to a charitable organization via the social networking environment. The user of a social network may also be provided with some type of information regarding the type of information that should be included when the desire to make a monetary charitable donation to a charitable organization via the social networking environment is expressed, such as, the name of the charitable organization and/or the dollar amount of the monetary charitable donation that the registered user of the payment processing organization wants to make to the charitable organization via the social networking environment.

If a user of a social network that is registered with the payment processing organization makes a monetary charitable donation to a charitable organization via the social networking environment and allows information regarding that donation to be viewed by other users of the social networking site—generally a subset of all users of the social networking site that are in some way connected to the user of the social networking site that made the donation or a subset of users that are specifically chosen by the user of the social networking site that made the donation—then the information that is viewed by other users of the social networking site may specify the specific characters that other users of the social networking site would be required to use if they wish to make a charitable monetary donation to a charitable organization via the social networking environment. For example, one specific example, would allow a user of a social networking site that had not previously registered with the payment processing organization to demonstrate his or her desire to make a charitable monetary donation to a charitable organization by posting “#donate” as a comment on a news feed and/or wall post regarding a charitable monetary donation to a charitable organization via the social networking environment and/or by posting “I #donate @[insert name of charitable organization]” or a similar sequence of characters via the social networking environment made by a user of the social networking site that was also a registered user of the payment processing organization.

When the API accesses the social networking environment of a user of a social network who is also a registered user of the payment processing organization and has provided the payment processing organization with access to his or her social networking environment, the API may search for the specified characters used to signal that the user of the social network wishes to make a monetary charitable donation to a charitable organization via the social networking environment. If the API identifies the requisite characters in the social networking environment of a registered user of the payment processing organization, this information may be transmitted to the payment processing organization. However, the specified characters may not have been placed in the social networking environment by the user of the social network who is also a registered user of the payment processing organization in whose social networking environment in which the characters were detected by the Application Program Interface of the payment processing organization. The specified characters may have been posted in the social networking environment of the registered user of the payment processing organization by a user of the social network who is not a registered user of the payment processing organization. If a user of a social networking site who is not registered with the payment processing organization posts information in the social networking environment of a user of the social network who is registered with the payment processing organization, and this information includes the specified characters required to indicate the desire of the user of the social network to make a monetary charitable donation to a charitable organization via the social networking environment, then the API may be able detect the presence of the specified characters in the social networking environment and the payment processing organization may be alerted of the desire of the user of the social network to make a donation to a charitable organization, even if the user of the social network who expressed the desire to make the donation has not previously registered with the payment processing organization.

When the API accesses the social networking environment of a charitable organization that is registered with the payment processing organization and has provided the payment processing organization with access to its social networking environment, the API may identify and/or collect information indicating that a user of the social network wishes to make a monetary charitable donation to that charitable organization via the social networking environment. If the API identifies and/or collects information from the social networking environment of a charitable organization that has also a registered with the payment processing organization, this information may be transmitted to the payment processing organization. However, a user of the social network that has previously registered with the payment processing organization may not have placed this information in the social networking environment of the charitable organization. If a user of a social networking site who has not registered with the payment processing organization posts information in the social networking environment of a charitable organization that is also registered with the payment processing organization, then the API may be able identify and/or this information and the payment processing organization may be alerted of the desire of the user of the social network to make a donation to a charitable organization, even if the user of the social network who expressed the desire to make the donation has not previously registered with the payment processing organization.

If a user of a social networking site expresses a desire to make a charitable monetary donation to a charitable organization via the social networking environment and the payment processing organization's API detects this information then the user of the social network may be contacted by the payment processing organization. If the user of the social network has not previously registered with the payment processing organization, the communication may direct the user of the social network to visit the Internet website of the payment processing organization and register with the payment processing organization before the charitable monetary donation that he or she expressed a desire to make may be processed. If the user of the social network has previously registered with the payment processing organization, the communication may document the donation that he or she expressed a desire to make and may provide the user of the social network with a period of time in which the donation may be canceled and thus not processed.

If a user of the social network who expressed a desire to make a monetary charitable donation to a charitable organization via the social networking environment subsequently registers with the payment processing organization then the donation may be processed in the same manner as a donation by a user of the social network who was registered with the payment processing organization prior to expressing a desire to make a monetary charitable donation to a charitable organization via the social networking environment. Once a user of a social networking site whose desire to make a donation to a charitable organization was identified and/or collected by the API registers with the payment processing organization, he or she may not need to leave the social networking environment for future donations to be identified and/or collected by the API of the payment processing organization, transmitted to the payment processing organization, and processed. Moreover, if the user of the social network that registered with the payment processing organization chooses to post information regarding a charitable donation that he or she made to a charitable organization via the social networking environment, the API may be able to identify and/or collect information from his or her connections in the social networking environment that is posted regarding that charitable monetary donation. Conversely, if the user of the social network does not register with the payment processing organization after his or her desire to make a charitable donation to a charitable organization is detected by the API of the payment processing organization then the donation may not be processed, meaning that the donation may not be made to the charitable organization.

The secured third-party provider may store credit card information of a user of a social network after the user of the social network registers with the payment processing organization. The organization that processes monetary charitable donations made by the users of a social networking site via the social networking environment and transmits those monetary charitable donations to the charitable organization to which the donation was made may also be a charitable organization. The charitable organizations that receive the monetary charitable donations made by users of a social network via the social networking environment may receive those donations directly from the charitable organization that processes the donations. The charitable organization that processes the donations that are made to a charitable organization via the social networking environment may do so after receiving information regarding the monetary charitable donation from the payment processing organization. For a user of a social network that has previously registered with the payment processing organization, this process may take place after information regarding the donation is received by the payment processing organization—from the API that identifies and/or collects information from the social networking environment—and after the user of the social network receives a notification regarding the monetary charitable donation—that was identified and/or collected by the API—from the payment processing organization and has the option of canceling that donation. For a user of a social network that has not previously registered with the payment processing organization, this process may take place after information regarding the donation is received by the payment processing organization—from the API that identifies and/or collects information from the social networking environment, after the user of the social network receives a notification regarding the monetary charitable donation—that was identified and/or collected by the API—from the payment processing organization, and after the user of the social networking site registers with the payment processing organization.

The secured third-party provider has specific protocols in place to comply with governmental requirements and ensure that credit card information is stored in a secured manner. Users of a social network that register with the payment processing organization may be provided with information in some form, typically as part of a written agreement that is signed electronically, regarding the secured third-party provider. This information may be provided when they register with the payment processing organization and are asked to provide their credit card information. Once the credit card information of the user of a social network that registers with the payment processing organization is obtained by the payment processing organization, typically during the registration process, that credit card information may be transferred from the payment processing organization to the secured third-party provider in which case a record of the credit card account information may not be maintained by the payment processing organization. The payment processing organization may request access to the credit card information of the user of the social networking site who registered with the payment processing organization from the secured third-party provider after the user of the social networking site who registered with the payment processing organization makes a donation to a charitable organization via the social networking environment. When the user of a social network who is registered with the payment processing organization makes a charitable monetary donation to a charitable organization via the social networking environment, the payment processing organization may request the credit card information of the user of the social network from the secured third-party provider. After a user of a social network who is registered with the payment processing organization makes a charitable monetary donation to a charitable organization via the social networking environment his or her credit card information may be stored by the charitable organization that processes the charitable monetary donations for the payment processing organization and may no longer be stored by the secured third-party provider.

When the charitable organization that processes monetary charitable donations processes a donation made by a user of a social networking site, the charitable organization that processes donations—transmitting the donation to the recipient charitable organization—may also transmit funds (e.g., cash, check, other monetary gift (regardless of amount), and/or the like) to the payment processing organization. In one example, the funds (e.g., cash, check, other monetary gift (regardless of amount), and/or the like) transmitted to the payment processing organization from the charitable organization that processes donations may take the form of a percentage of the donation—that was made to a charitable organization by a user of a social network, who is also registered with the payment processing organization, via the social networking environment—that the charitable organization processed. The funds that are transmitted from the charitable organization that processes donations to the payment processing organization may be transmitted to the payment processing organization at various points in time, for example, they may be transmitted either when each monetary charitable donation made by a user of a social network is processed or at set intervals that are based either on a specified period of time, a specified amount of donations, some combination of these two approaches, and/or the like.

Referring to FIG. 8, social media platform 110 includes a donor account 802 (e.g., which may be an initiator account), a charity account 804 (which may be a receiver account), and content 808. For example, the charity account 804 can create content 608 to advertise services (e.g., products, donation campaigns, etc.). The content can include a page on the social media platform 110, a post on a page, a comment on a post, etc. Donor account 802 can generate content to initiate a donation campaign, which may relate to content generated by the charity account 804 or the charity account 804 generally. The content generated by donor account 802 can correspond to a post on content generated by the charity account 804, a comment on content generated by the charity account 804, a share of content generated by the charity account 804, a post, comment, message, etc. that indicates the charity account 804, and/or the like. Donor account 802 can also create a donor payor account 820 on the payment management platform 102, which may be linked to the donor account 802. In one example, the donor account 802 can login to the payment management platform 102 using the social media account.

Social media platform 110 can notify the payment management platform 102 of donor account activity and/or charity account activity, etc. In one example, payment management platform 102 may begin to monitor content related to content generated by the charity account 804 based at least in part on receiving a notification of the content generated by charity account 804 from the social media platform 110. In addition, in this regard, where donor account 802 generates the content to initiate the financial transaction, based on notification thereof to the payment management platform 102, a financial transaction with payment information can be created for the donor account 802 activity and linked to donor payor account 820. In any case, donor payor account 820 can pay an amount to the charity payee account 822 linked to the charity account 804 based on the initiated financial transaction.

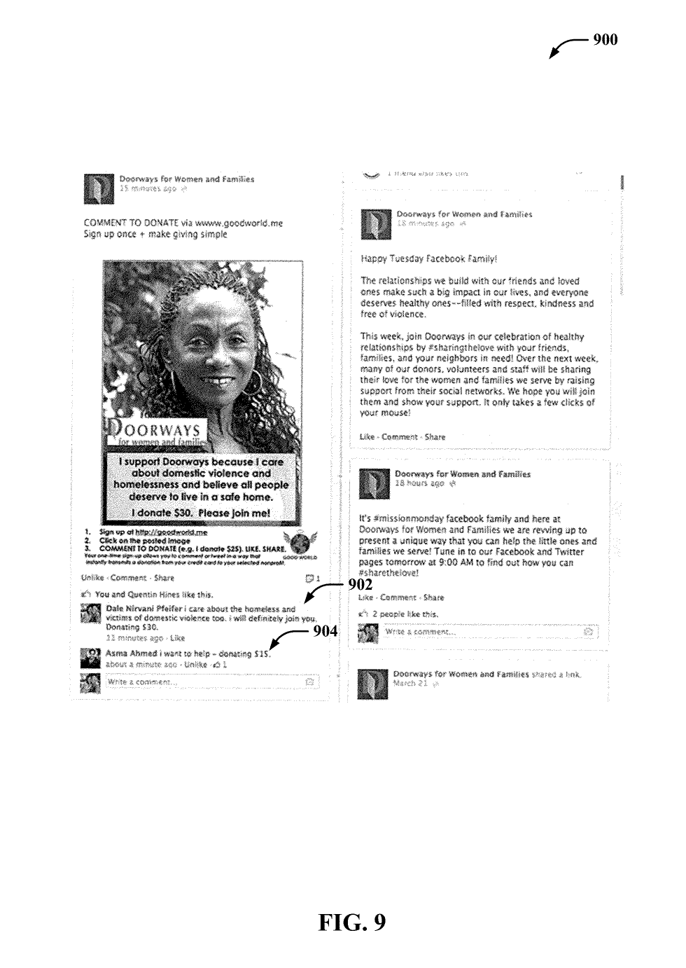

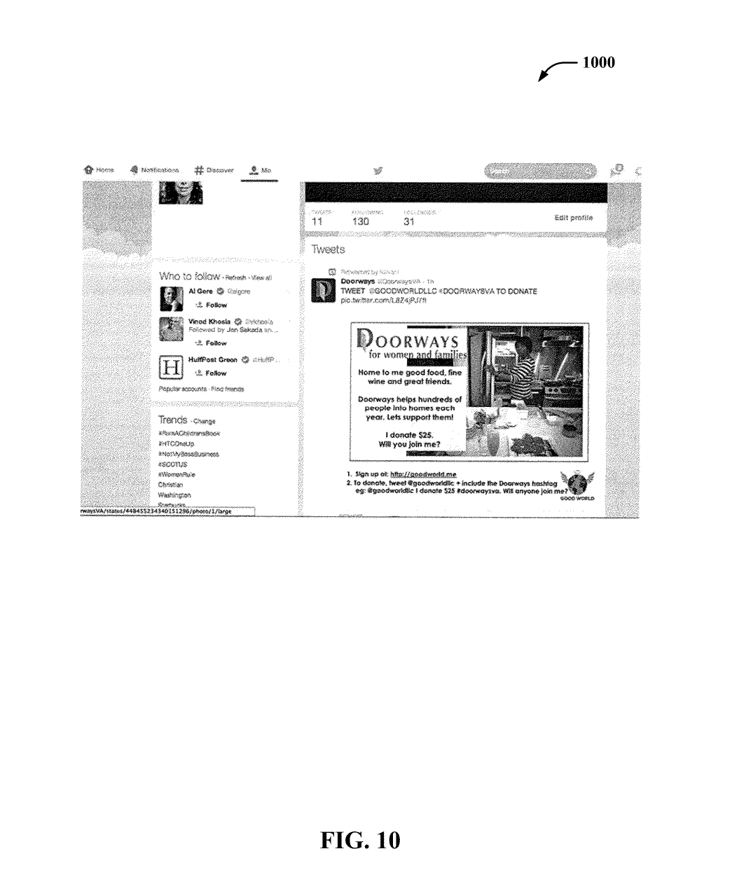

FIGS. 9 and 10 illustrate example interfaces 900 and 1000 of social media feeds representing a user (e.g., a receiver account) of a social networking site. The social media feeds present donation campaign posts/messages, and interface 900 also illustrates example initiator account comments 902 and 904 such to trigger donations by the payment management platform by using sequences of characters (e.g., “donating”).

A user of a social networking site that has registered with the payment processing organization and makes a donation to a charitable organization via the social networking environment may have an option of posting information regarding that donation in the social networking environment, making that information viewable to other users of the social network in the social networking environment. The users of a social networking site that are able to view this information may be individuals that the user of the social networking environment is connected to through the social networking environment or a select group of users of the social network.

Users of a social network who view information posted by a user of the social network who is registered with the payment processing organization and has made a donation to a charitable organization via the social networking environment may be able to post information in response to that individuals donation expressing their desire to also make a donation to the charitable organization via the social networking environment. Information regarding the desire of the user of the social network to also make a donation to the charitable organization via the social networking environment may be identified and/or collected by the API of the payment processing organization, regardless of whether the user of the social network that expressed a desire to make a monetary charitable donation to the charitable organization has previously registered with the payment processing organization.

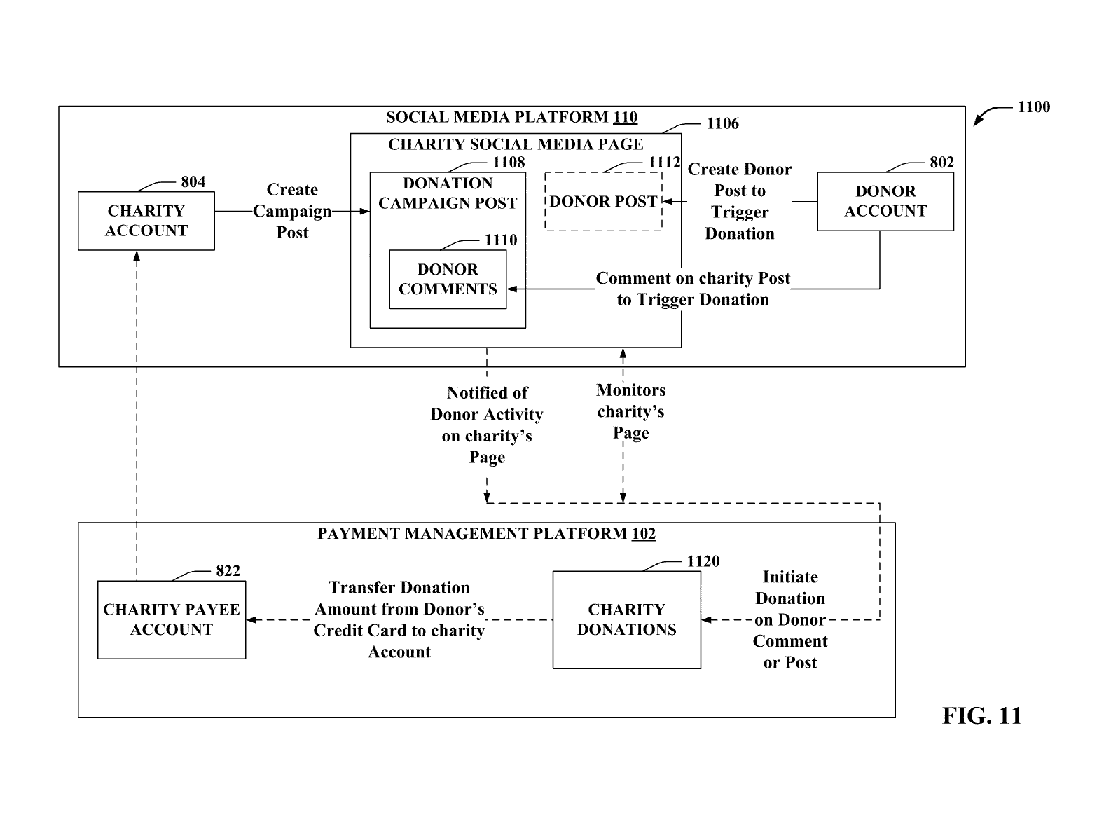

FIG. 11 illustrates another example flowchart 1100 of data between a social media platform 110 and payment management platform 102, as described herein. Social media platform 110 includes a donor account 802 (e.g., which may be an initiator account), a charity account 804 (which may be a receiver account), and a charity social media page 1106. For example, the charity social media page 1106 may advertise a donation campaign for which donations may be initiated. In one example, charity account 804 may also generate a donation campaign post 1108 on the social media page 1106. In an example, social media platform 110 may notify the payment management platform 102 of the social media page 1106, the donation campaign post 1108, and/or the like, which the payment management platform 102 can then monitor for additional content related to donations.

In an example, donor account 802 can comment 1110 on the financial transaction post to trigger a donation (e.g., the comment can include the sequence of characters to initiate the donation). In another example, initiator account 152 may generate a donor post 1112 on the charity social media page 1106 to trigger the transaction (e.g., the comment can include the sequence of characters to initiate the donation). In either case, the payment management platform 102 can be notified of the activity on the charity social media page 1106, and may accordingly initiate a donation in charity donations 1120 based on detecting the sequence of characters in the donor comments 1110 and/or the donor post 1112. This can cause a transfer of a donation amount from the donor to the charity payee account 822, where the charity payee account 822 is linked to the charity account 804. For example, the transfer of the donation amount may be initiated from a donor payor account related to the donor account 802, based on payment information specified by the donor account 802, etc.

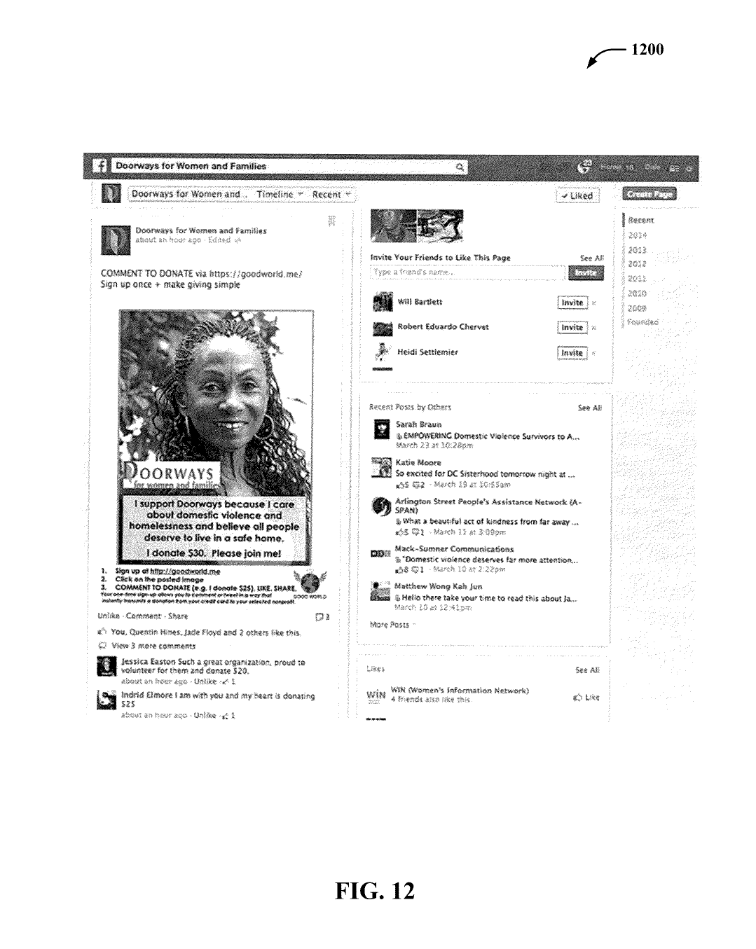

FIG. 12 illustrates an example interface 1200 of social media feeds representing a user (e.g., a receiver account) of a social networking site, where the user is actively soliciting donations from users (e.g., initiator accounts) of the social networking site.

For example, the payment processing organization may work directly with a charitable organization to solicit monetary charitable donations from users of a social networking site, and this can be done in a variety of manners.

Some of the various examples herein may involve the payment processing organization assisting a charitable organization in setting up a campaign-based approach to solicit donations from users of a social networking site via the social networking environment. The campaign-based approach may involve the payment processing organization working directly with the charitable organization to organize a campaign-based approach to soliciting funds from users of a social networking site. One example of the campaign-based approach to soliciting funds from users of a social networking site via the social networking environment involves setting a specific monetary goal that is tied to the amount of money that a charitable organization desires to complete a specified project. The payment processing organization may work directly with a charitable organization to set up a campaign to solicit money from users of the social networking environment to meet the specific monetary goal set by the charitable organization to complete the specified project. The payment processing organization may work with the charitable organization to inform users of the social networking site about the charitable organization and the organization's monetary need as it relates to the specific project that the charitable organization wishes to undertake. For example, the payment processing organization may work with a charitable organization to set up a page, group, or another means of providing users of the social networking environment with information regarding the charitable organization as well as the monetary needs of the organization as it relates to the project that the organization wishes to undertake.

The charitable organization that wishes to solicit donations from users of a social networking site via the social networking environment using a campaign-based approach may be required to register with the payment processing organization. To register with the payment processing organization, the charitable organization may be required to visit the Internet website of the payment processing organization and provide the payment processing organization with certain information, which may include the social network information of the charitable organization (e.g., the organization's social media page). The charitable organization may also be required to build a campaign. Before posting the campaign that the charitable organization created in the social networking environment (the campaign advertisement), there is certain information that may need to be included in the campaign advertisement. The information that may need to be included in the campaign advertisement may include the payment processing organization's instructions regarding how the user of a social networking site can make a donation to the charitable organization via the social networking environment.

According to some examples, the charitable organization may use a core support group, which may be comprised of individuals or entities that work to publicize the campaign and kick off the networking effect of donating money to the charitable organization via the social networking environment. This core group of individuals may be responsible for helping to spread the word about the charitable organization or the charitable organization's campaign by making monetary charitable donations to the charitable organization via the social networking environment and/or sharing information about the charitable organization and/or the charitable organization's campaign. The information that may be shared by the core group may include content created by the charitable organization.

The core support group may be comprised of champions and/or ambassadors. Champions are typically individuals who have a large number of connections in the social networking environment that is being for the campaign of the charitable organization and their tasks may include sharing content and/or making donations to the campaign of the charitable organization to spark the networking effect. Personal messages may also be sent by the charitable organization and the organizations' champions and/or ambassadors to inform individuals or entities of the charitable organization's campaign. Not all communications regarding the campaign may be required to take place within the social networking environment, for example, some communications may take place as a result of champions and/or ambassadors sending an email to friends and family so they can be first to donate. Champions, ambassadors, and/or the charitable organization may also use a blog(s) or other form of media to gamer additional support for the charitable organization's campaign that is taking place in the social networking environment. The charitable organization may also set up a closed social networking group to give insider up-dates and rally supporters. Ambassadors may be individuals such as celebrities, thought-leaders, or others with high clout that may be used by the charitable organization to get other individuals involved with the charitable organization's campaign. Generally, all that is required from ambassadors is a photo, a quote, and an agreement from them to share their campaign advertisement in the social networking environment. Ambassadors may also be used to propel the networking effect of the campaign forward.

Charitable organizations that utilize a campaign-based approach may use a service that automatically posts advertisements regarding the charitable organization's campaign in the social networking environment. The charitable organization may also post textual updates regarding the status of the campaign that may be able to be viewed by users of the social networking environment. After the monetary goal for the campaign that was set by the charitable organization has been reached or the timeframe set for the campaign has ended, the charitable organization may wish to thank individuals who provided donations to the charitable organization's campaign via the social networking environment. The charitable organization may also wish to let supporters watch the project funded by the campaign come to life, for example, by sharing information with supporters regarding decisions made by the charitable organization, by explaining to supporters how it feels as the goal of the charitable organization becomes a reality, and/or by asking supporters for feedback.

Before, during, and/or after a charitable organization's campaign, the charitable organization may receive funds (e.g., cash, check, other monetary gift (regardless of amount), and/or the like) from charitable monetary donations made by users of the social networking site via the social networking environment. These funds may be transmitted to the charitable organization at specified intervals.

The payment processing organization may also set up an educational module or program, such as a “Giving School,” whereby charitable organizations may receive information and/or otherwise learn how to raise money via a social networking environment. This may include providing the charitable organization with information and/or otherwise informing the charitable organization regarding how to raise money through the social networking environment utilizing a campaign-based approach. For example, the charitable organization may learn about the most effective marketing strategies to solicit money from users of a social networking site via the social networking environment. In one example there would be specific online modules that a charitable organization could complete and each module would provide the organization with information related to soliciting monetary charitable donations from users of a social networking site via the social networking environment.

Other examples may involve a campaign builder, which is a social media management system for businesses and/or organizations to collaboratively execute campaigns across multiple social networks (and this may be done from one secure, web-based dashboard). Businesses and/or organizations may be able to launch fundraising campaigns, identify and grow audiences, distribute targeted messages, and deliver analytics using a social media dashboard. The social network integrations may include a number of social networking sites. The services provided may include things such as planning and campaign development, website design and build, and on-going audience activation via email, social, video and paid media. There may also be automated processes for aspects of the campaign, including items such as a campaign scheduler, an online design tool, campaign marketing services, analytics, and event management. The campaign scheduler may include scheduling and assignment tools and the campaign scheduler may reach audiences with geo-targeting functionality. The campaign scheduler may be used to invite multiple collaborators to manage social profiles securely, and the campaign schedule may provide custom reports using the comprehensive social analytics tools for measurement. The online design tool may make it easy to use drag-and-drop interface that provides users with to a wide array photographs, graphics, and fonts that can be used to create campaign collateral. The campaign marking services may include email marketing, social media marketing, event marketing, and online survey tools to help small organizations grow their businesses, including by building stronger customer relationships. The analytics tools may be used to measure search, social, link building, and brand marketing efforts, and the analytic tools may provide recommendations and insight into improving each of these channels. The event management tools may also provide event management solutions to drive donations and help make events successful (prior, during, and post events).

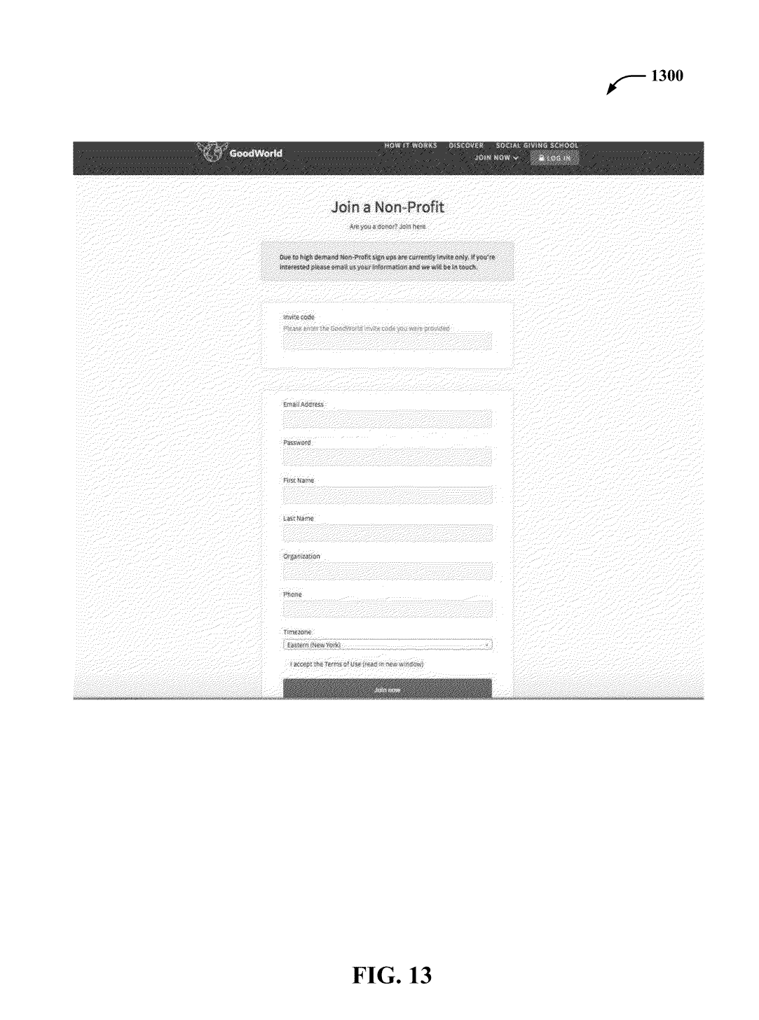

FIGS. 13-22 illustrate example interfaces in accordance with aspects described herein with respect to implementation of payment management platform 102. In some aspects, the interfaces may include graphical user interface (GUI) screens configured to interact with one or more of the various modules/components described herein for providing/receiving information to/from users. This functionality may include substantially any suitable type of application that sends, retrieves, processes, and/or manipulates input data, receives, displays, formats, and/or communicates output data. For example, such interfaces may also be associated with an engine, editor tool, web browser, device application, etc., although other type applications may be utilized. The GUI may include a display having one or more display objects comprising, e.g., configurable icons, buttons, sliders, input boxes, selection options, menus, tabs having multiple configurable dimensions, shapes, colors, text, data and sounds to facilitate operations with the interfaces. In addition, among other things, the GUI may also receive and process user commands from a mouse, touch screen, keyboard, laser pointer, speech input, web site, remote web service and/or other devices such as a camera and/or video content, etc. to affect or modify operations and/or display of the GUI.

FIG. 13 illustrates an example GUI screen 1300 for registering a charitable organization with the payment management platform 102 (e.g., as a payee account), as described above.

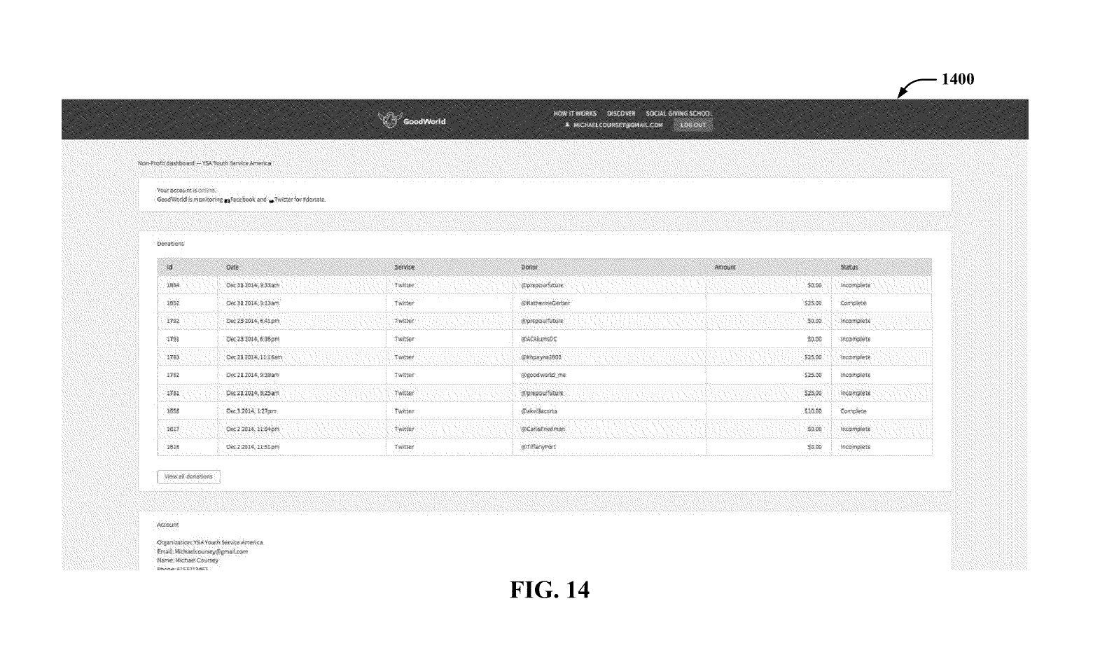

FIG. 14 shows an example GUI screen 1400 that presents a portion of a payee dashboard for a charitable organization, in accordance with aspects described above.

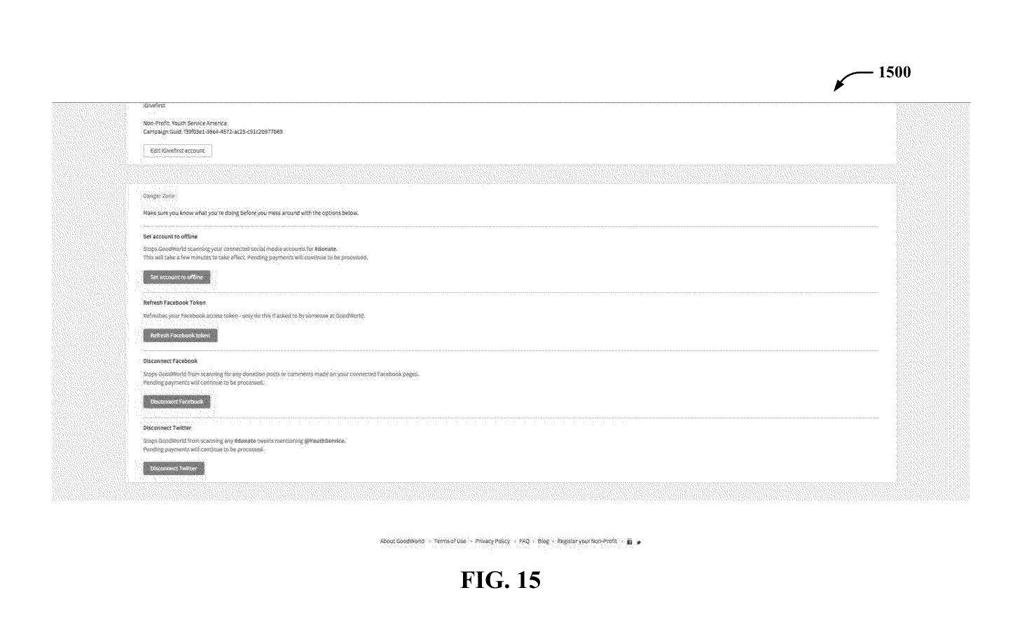

FIG. 15 shows another example GUI screen 1500 that presents another portion of a payee dashboard for a charitable organization, in accordance with aspects described above.

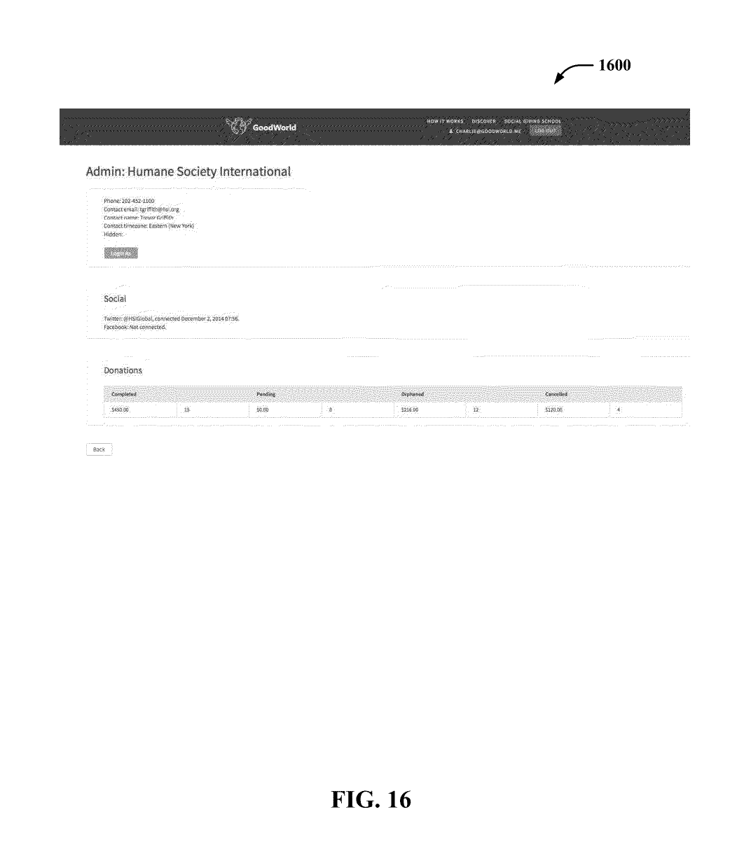

FIG. 16 shows an example GUI screen 1600 that provides information regarding donations received for the charitable organization payee.

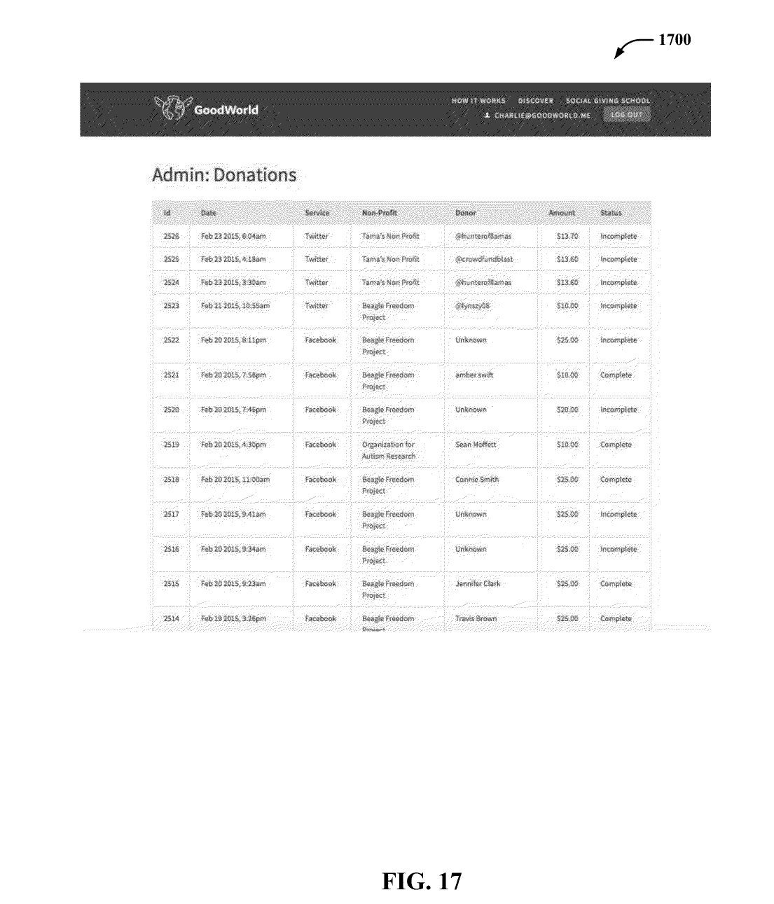

FIG. 17 depicts an example GUI screen 1700 that displays a plurality of donations processed for the charitable organization payee based on social media content, as described herein.

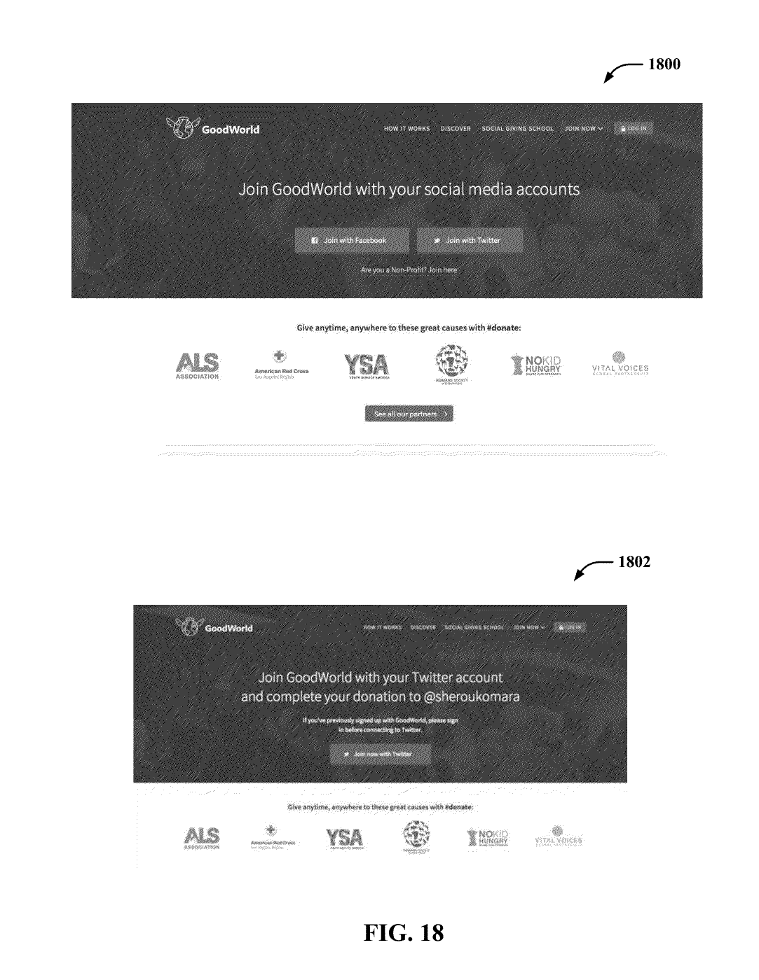

FIG. 18 depicts example GUI screens 1800 and 1802 that present an invitation to register a donor with the payment management platform 102 (e.g., where the payment management platform 102 cannot locate a donor account associated with an initiator account), as described herein.

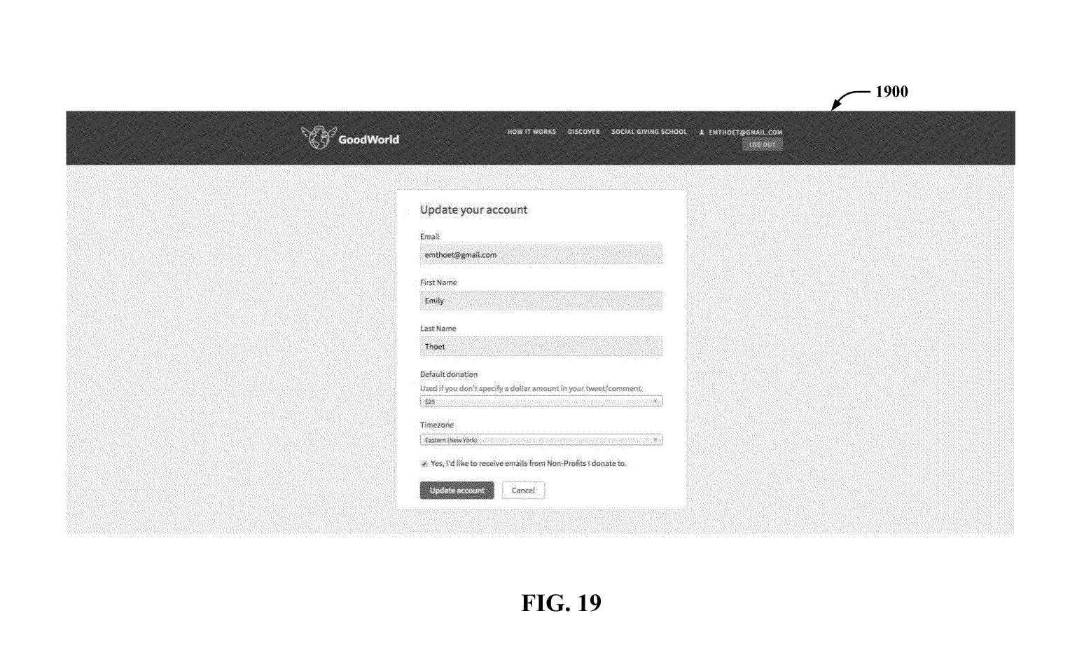

FIG. 19 illustrates an example GUI screen 1900 for establishing or updating a donor account.

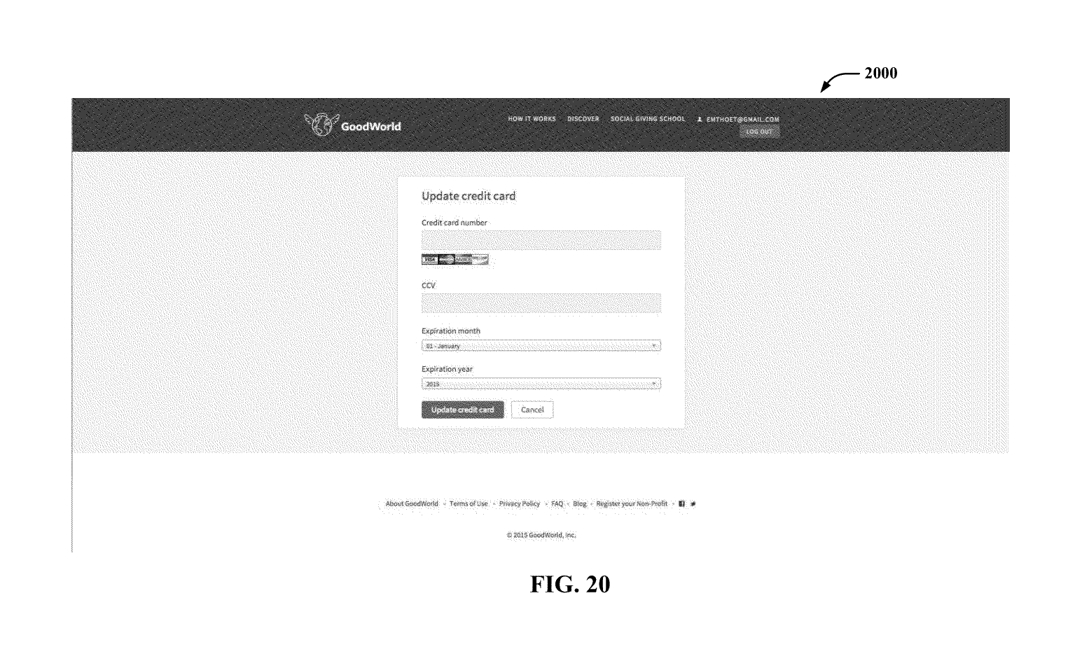

FIG. 20 illustrates an example GUI screen 2000 for specifying credit card information for a donor account.

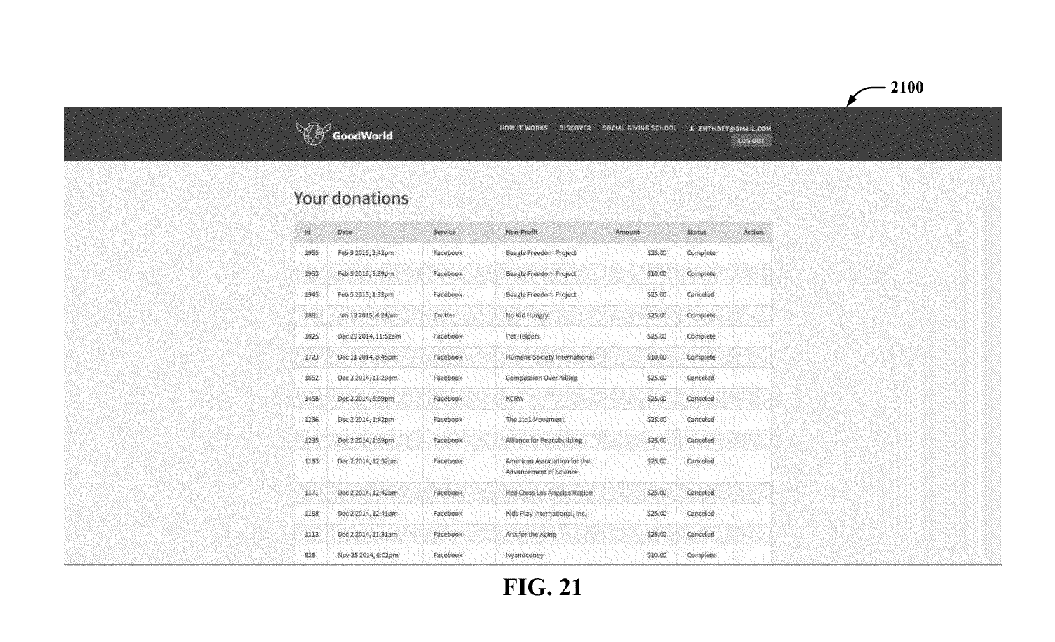

FIG. 21 illustrates an example GUI screen 2100 that displays donations processed for a donor account (e.g., a donor dashboard as described herein).

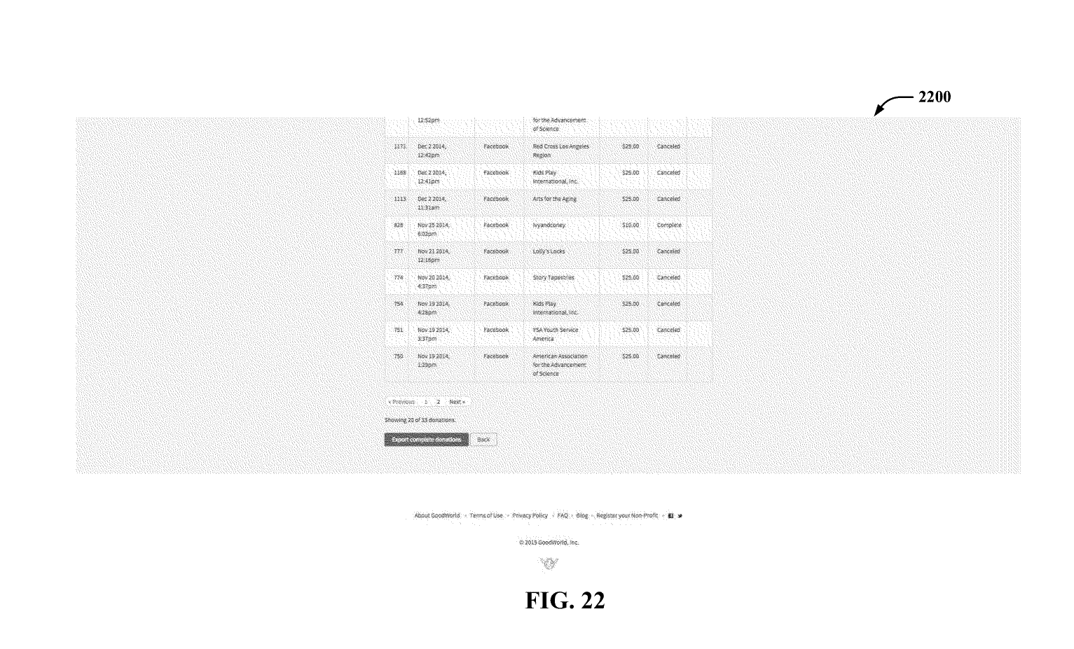

FIG. 22 illustrates an example GUI screen 2200 that displays another portion of the donations process for a donor account with an option to export the donations.

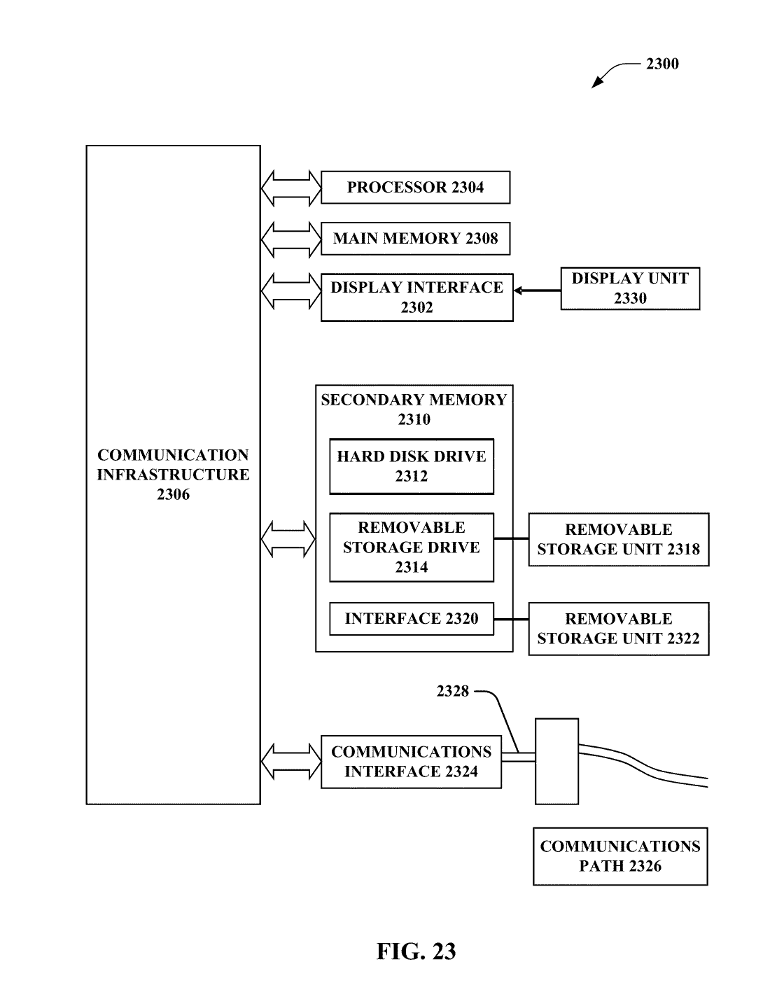

In some variations, aspects described herein may be directed toward one or more computer systems capable of carrying out the functionality described herein. An example of such a computer system 2300 is shown in FIG. 23.

Computer system 2300 may include one or more processors, such as processor 2304. The processor 2304 is connected to a communication infrastructure 2306 (e.g., a communications bus, cross-over bar, or network). Various software aspects are described in terms of this example computer system. After reading this description, it will become apparent to a person skilled in the relevant art(s) how to implement the described subject matter using other computer systems and/or architectures.

Computer system 2300 may include a display interface 2302 that forwards graphics, text, and other data from the communication infrastructure 2306 (or from a frame buffer not shown) for display on a display unit 2330. Computer system 2300 also includes a main memory 2308, preferably random access memory (RAM), and may also include a secondary memory 2310. The secondary memory 2310 may include, for example, a hard disk drive 2312 and/or a removable storage drive 2314, representing a floppy disk drive, a magnetic tape drive, an optical disk drive, a flash memory drive, etc. The removable storage drive 2314 reads from and/or writes to a removable storage unit 2318 in a well-known manner. Removable storage unit 2318, represents a floppy disk, magnetic tape, optical disk, flash memory card, etc., which is read by and written to removable storage drive 2314. As will be appreciated, the removable storage unit 2318 includes a computer usable storage medium having stored therein computer software and/or data.

In alternative aspects, secondary memory 2310 may include other similar devices for allowing computer programs or other instructions to be loaded into computer system 2300. Such devices may include, for example, a removable storage unit 2322 and an interface 2320. Examples of such may include a program cartridge and cartridge interface (such as that found in video game devices), a removable memory chip (such as an erasable programmable read only memory (EPROM), or programmable read only memory (PROM)) and associated socket, and other removable storage units 2322 and interfaces 2320, which allow software and data to be transferred from the removable storage unit 2322 to computer system 2300.

Computer system 2300 may also include a communications interface 2324. Communications interface 2324 allows software and data to be transferred between computer system 2300 and external devices. Examples of communications interface 2324 may include a modem, a network interface (such as an Ethernet card), a communications port, a Personal Computer Memory Card International Association (PCMCIA) slot and card, etc. Software and data transferred via communications interface 2324 are in the form of signals 2328, which may be electronic, electromagnetic, optical or other signals capable of being received by communications interface 2324. These signals 2328 are provided to communications interface 2324 via a communications path (e.g., channel) 2326. This path 2326 carries signals 2328 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 2314, a hard disk installed in hard disk drive 2312, and signals 2328. These computer program products provide software to the computer system 2300. Aspects of the described subject matter may be directed to such computer program products.

Computer programs (also referred to as computer control logic) are stored in main memory 2308 and/or secondary memory 2310. Computer programs may also be received via communications interface 2324. Such computer programs, when executed, enable the computer system 2300 to perform the features of the subject matter described herein. In particular, the computer programs, when executed, enable the processor 2304 to perform the features of the described subject matter. Accordingly, such computer programs represent controllers of the computer system 2300.

In an aspect where the aspects described herein are implemented using software, the software may be stored in a computer program product and loaded into computer system 2300 using removable storage drive 2314, hard disk drive 2312, or interface 2320. The control logic (software), when executed by the processor 2304, causes the processor 2304 to perform the functions of the subject matter described herein. In another aspect, the subject matter described herein may be implemented primarily in hardware using, for example, hardware components, such as application specific integrated circuits (ASICs). Implementation of the hardware state machine so as to perform the functions described herein will be apparent to persons skilled in the relevant art(s). In yet another aspect, variations of the described subject matter may be implemented using a combination of both hardware and software.

In one example, display interface 2302 may provide interfaces related to the payment management platform 102 (e.g., provided by account registering component 126, dashboard providing component 138, etc.) or related GUI screens 1400, 1500, 1600, 1700, 1800, 1900, 2000, 2100, 2200, and/or similar interfaces as described herein. Interaction with these interfaces may be provided via input devices connected to communication infrastructure 2306, such as a keyboard, mouse, touch screen, voice input, and/or the like.

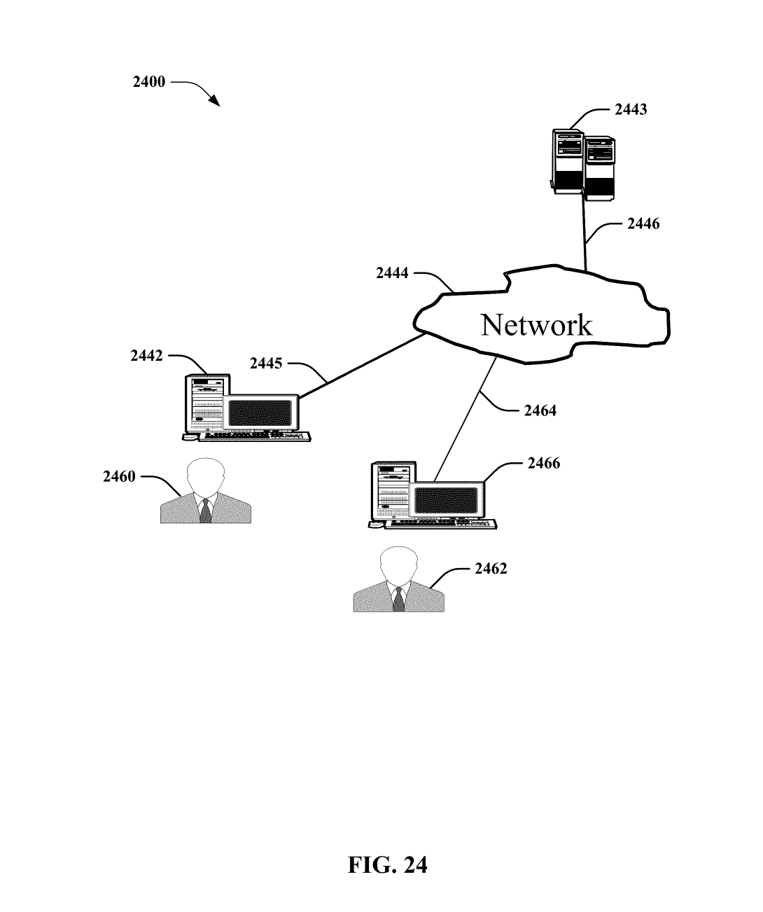

FIG. 24 shows a communication system 2400 involving use of various features in accordance with aspects described herein. The communication system 2400 may include one or more assessors 2460, 2462 (also referred to interchangeably herein as one or more “users”, “entities,” etc.) and one or more terminals 2442, 2466 accessible by the one or more accessors 2460, 2462. In one aspect, operations in accordance with aspects described herein may include, for example, input and/or accessed by an accessor 2460 via terminal 2442, such as personal computers (PCs), minicomputers, mainframe computers, microcomputers, telephonic devices, or wireless devices, such as personal digital assistants (“PDAs”) or a hand-held wireless devices coupled to a remote device 2443, such as a server, PC, minicomputer, mainframe computer, microcomputer, or other device having a processor and a repository for data and/or connection to a repository for data, via, for example, a network 2444, such as the Internet or an intranet, and couplings 2445, 2464. The couplings 2445, 2464 include, for example, wired, wireless, or fiber optic links. In another aspect, the methods and systems described herein may operate in a stand-alone environment, such as on a single terminal.

While the foregoing has been described in conjunction with the example aspects outlined above and further described in the figures, various alternatives, modifications, variations, improvements, and/or substantial equivalents, whether known or that are or may be presently unforeseen, may become apparent to those having at least ordinary skill in the art. Accordingly, the exemplary aspects, as set forth above, are intended to be illustrative, not limiting. Various changes may be made without departing from the spirit and scope of the subject matter described herein. Therefore, aspects described herein intended to embrace all known or later-developed alternatives, modifications, variations, improvements, and/or substantial equivalents.

What is claimed is:

1. A method for facilitating financial transactions to a payee account based on social media content, comprising:
receiving content from the social media platform relating to the payee account;
detecting a sequence of characters in the content indicating initiation of a financial transaction;
determining an initiator account on the social media platform that is associated with the sequence of characters; and
initiating the financial transaction based at least in part on the initiator account, detecting the sequence of characters, and the payee account.

2. The method of claim 1, wherein initiating the financial transaction comprises initiating a payment from a payor account associated with the initiator account in a payment management platform to the payee account.

3. The method of claim 2, wherein the sequence of characters specifies a payment amount associated with the financial transaction, and wherein initiating the financial transaction comprises initiating the payment for the payment amount.

4. The method of claim 2, wherein the sequence of characters does not specify a payment amount, and wherein initiating the financial transaction comprises initiating the payment for a default payment amount configured by the payor account.

5. The method of claim 2, wherein the payor account comprises configured payment information, and wherein initiating the payment is based at least in part on the configured payment information.

6. The method of claim 5, further comprising receiving at least the payment information and information regarding the initiator account in a configuration related to the payor account.

7. The method of claim 2, further comprising: processing the payment after a grace period from initiating the payment; and allowing cancellation of the payment by the payor account during the grace period.

8. The method of claim 2, further comprising generating a receipt for the payment to the payor account on behalf of the payee account.

9. The method of claim 2, further comprising displaying a dashboard of pending and/or completed donations for the payor account over a plurality of social media platforms including the social media platform.

10. The method of claim 1, further comprising determining the content relates to the payee account based at least in part on determining a receiver account in the social media platform related to the content, wherein the receiver account corresponds to the payee account.

11. The method of claim 10, wherein the content comprises at least one of a post by the initiator account to a page related to the receiver account on the social media platform, a comment by the initiator account to a post related to the receiver account on the social media platform, or a message on the social media platform by the initiator account that indicates the receiver account.

12. The method of claim 1, further comprising subscribing to the social media platform to receive the content based at least in part information specified in the payee account.

13. The method of claim 12, wherein the information corresponds to a receiver account in the social media platform that corresponds to the payee account.

14. The method of claim 1, wherein determining the initiator account that is associated with the content comprises determining that the initiator account authored the content.

15. The method of claim 1, wherein the payee account relates to a charitable organization, the initiator account relates to a donor, and the content relates to the donor initiating a donation to the charitable organization.

16. The method of claim 1, further comprising sending a confirmation that the financial transaction was initiated to the initiator account over the social media platform.

17. The method of claim 1, further comprising displaying a dashboard of pending and/or completed donations for the payee account over a plurality of social media platforms including the social media platform.

18. A system for facilitating financial transactions to a payee account based on social media content, comprising:
a platform integrating component configured to receive content from the social media platform relating to the payee account;
a content processing component configured to detect a sequence of characters in the content indicating initiation of a financial transaction, and determine an initiator account on the social media platform that is associated with the sequence of characters; and
a transaction-initiating component configured to initiate the financial transaction based at least in part on the initiator account, detecting the sequence of characters, and the payee account.

19. The system of claim 17, wherein the transaction-initiating component is configured to initiate a payment from a payor account associated with the initiator account in a payment management platform to the payee account.

20. The system of claim 19, wherein the sequence of characters specifies a payment amount associated with the financial transaction, and wherein the transaction-initiating component is configured to initiate the payment for the payment amount.

21. The system of claim 19, further comprising an account registering component configured to receive at least the payment information and information regarding the initiator account in a configuration related to the payor account.

22. A non-transitory computer-readable medium for facilitating financial transactions to a payee account based on social media content, comprising:
code for receiving content from the social media platform relating to the payee account;
code for detecting a sequence of characters in the content indicating initiation of a financial transaction;
code for determining an initiator account on the social media platform that is associated with the sequence of characters; and
code for initiating the financial transaction based at least in part on the initiator account, detecting the sequence of characters, and the payee account.
